(19) United States
(12) Patent Application Publication
(10) Pub. No.: US 2013/0157168 A1
(43) Pub. Date: Jun. 20, 2013

(54) COMPOSITION, COMPOSITE PREPARED FROM THE COMPOSITION, ELECTRODE AND ELECTROLYTE MEMBRANE FOR FUEL CELL EACH INCLUDING THE SAME, METHOD OF PREPARING THE ELECTROLYTE MEMBRANE, AND FUEL CELL INCLUDING THE SAME

(71) Applicant: Samsung Electronics Co., Ltd., Suwon-si (KR)

(72) Inventors: Pil-won HEO, Yongin-si (KR); Ki-hyun KIM, Yongin-si (KR); Seong-woo CHOI, Yongin-si (KR)

(73) Assignee: SAMSUNG ELECTRONICS CO., LTD., Suwon-si (KR)

(21) Appl. No.: 13/720,944

(22) Filed: Dec. 19, 2012

(30) Foreign Application Priority Data
Dec. 19, 2011 (KR) 10-2011-0137410

(51) Int. Cl. H01M 4/90; H01M 8/10

(52) U.S. Cl. CPC H01M 4/9008; H01M 8/103; H01M 8/10; H01M 8/1041
USPC 429/482; 429/492; 264/104

(57) ABSTRACT

A composition including a compound represented by Formula 1, an azole-based polymer, and at least one of compounds represented by Formula 2-7 according to the specification, a composite obtained from the composition, an electrode and electrolyte for a fuel cell that include the composition or the composite, and a fuel cell including the electrode or the electrolyte membrane:

M¹₁₋ₐM²ₐPₓO_{y} Formula 1
wherein, in Formula 1, M¹ is a tetravalent element; M² is at least one selected from the group including a monovalent element, a divalent element, and a trivalent element; 0≦a<1; x is a number from 1.5 to 3.5; and y is a number from 5 to 13.

### CROSS-REFERENCE TO RELATED APPLICATIONS

This application claims priority to and the benefit of Korean Patent Application No. 10-2011-0137410, filed on Dec. 19, 2011, and all the benefits accruing therefrom under 35 U.S.C. §119, the content of which is incorporated herein in its entirety by reference.

### BACKGROUND

1. Field

The present disclosure relates to a composition, a composite prepared from the composition, an electrode and electrolyte membrane for a fuel cell that each include the composition or the composite, a method of preparing the electrolyte membrane, and a fuel cell including the electrode or the electrolyte membrane.

2. Description of the Related Art

According to types of an electrolyte and fuel used, fuel cells can be classified as polymer electrolyte membrane fuel cells (“PEMFCs”), direct methanol fuel cells (“DMFCs”), phosphoric acid fuel cells (“PAFCs”), molten carbonate fuel cells (“MCFCs”), or solid oxide fuel cells (“SOFCs”).

PEMFCs operating at 100° C. or higher temperatures in non-humidified conditions, as compared to those operable at low temperatures, do not need a humidifier, and are known to be convenient in terms of control of water supply and highly reliable in terms of system operation. Furthermore, such PEMFCs may become more durable against carbon monoxide (CO) poisoning that may occur with fuel electrodes as they operate at high temperatures, and thus, a simplified reformer may be used therefor. These advantages mean that PEMFCs are increasingly drawing attention for use in such high-temperature, non-humidifying systems.

Along with the current trends for increasing the operation temperature of PEMPCs as described above, fuel cells operable at high temperatures are drawing more attention. However, electrolyte membranes of fuel cells that have been developed so far do not exhibit satisfactory conductivity, mechanical strength and durability at high temperatures, and thus, still need further improvement.

### SUMMARY

Provided are a composition, a composite prepared from the composition, an electrode and electrolyte membrane for a fuel cell that each include the composition or the composite, a method of preparing the electrolyte membrane, and a high-performance fuel cell including the electrode or the electrolyte membrane.

Additional aspects will be set forth in part in the description which follows and, in part, will be apparent from the description, or may be learned by practice of the presented embodiments.

According to an aspect, there is provided a composition including: a compound represented by Formula 1 below; an azole-based polymer; and at least one of compounds represented by Formulae 2 to 7 below:

M¹₁₋ₐM²ₐPₓO_{y} Formula 1

wherein, in Formula 1, M¹ is a tetravalent element;
M² is at least one selected from the group including a monovalent element, a divalent element, and a trivalent element;
0≦a<1;
x is a number from 1.5 to 3.5; and
y is a number from 5 to 13,

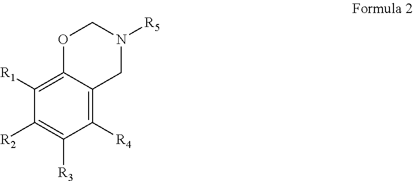

wherein, in Formula 2, R₁, R₂, R₃, and R₄ are each independently a hydrogen atom, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₂-C₂₀ heteroaryl group, a substituted or unsubstituted C₂-C₂₀ heteroaryloxy group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, a halogen atom, a hydroxyl group, or a cyano group; and
R₅ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group,

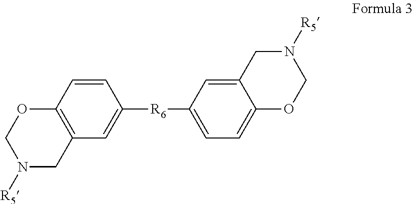

wherein, in Formula 3, R₅′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and
R₆ is a substituted or unsubstituted C₁-C₂₀ alkylene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₂-C₂₀ heteroarylene group, —C(═O)—, or —SO₂—,

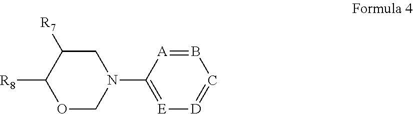

wherein, in Formula 4, A, B, C, D and E are carbon, or one or two of A, B, C, D and E is nitrogen and the others are carbon; and
R₇ and R₈ are linked to form a ring, wherein the ring is a C₆-C₁₀ cycloalkyl group, a C₃-C₁₀ heteroaryl group, a fused C₃-C₁₀ heteroaryl group, a C₃-C₁₀ heterocyclic group, or a fused C₃-C₁₀ heterocyclic group,

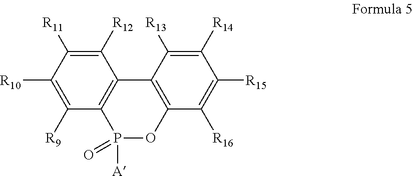

wherein, in Formula 5, A′ is a substituted or unsubstituted C₁-C₂₀ heterocyclic group, a substituted or unsubstituted C₄-C₂₀ cycloalkyl group, or a substituted or unsubstituted C₁-C₂₀ alkyl group; and
R₉ to R₁₆ are each independently a hydrogen atom, a C₁-C₂₀ alkyl group, a C₁-C₂₀ alkoxy group, a C₆-C₂₀ aryl group, a C₆-C₂₀ aryloxy group, a C₁-C₂₀ heteroaryl group, a C₁-C₂₀ heteroaryloxy group, a C₄-C₂₀ cycloalkyl group, a C₁-C₂₀ heterocyclic group, a halogen atom, a cyano group, or a hydroxy group,

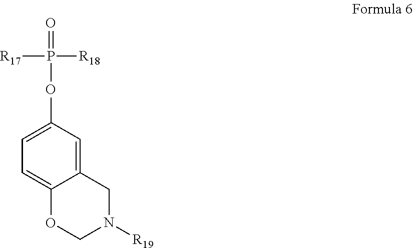

wherein, in Formula 6, R₁₇ and R₁₈ are each independently a C₁-C₂₀ alkyl group, a C₁-C₂₀ alkoxy group, a C₆-C₂₀ aryl group, a C₆-C₂₀ aryloxy group, or a group represented by Formula 6A below:

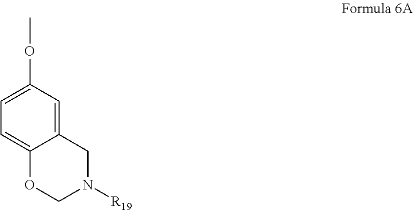

wherein, in Formulae 6 and 6A, R₁₉ and R₁₉′ are each independently a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ cycloalkyl group, a halogenated C₄-C₂₀ cycloalkyl group, a C₁-C₂₀ heterocyclic group, or a halogenated C₁-C₂₀ heterocyclic group,

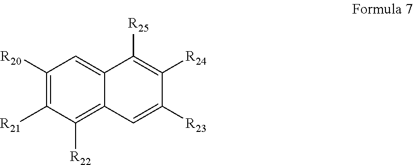

wherein, in Formula 7, two adjacent groups selected from R₂₀, R₂₁, and R₂₂ are linked to form a group represented by Formula 7A below;
the unselected rest of R₂₀, R₂₁ and R₂₂ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbocyclic group, a halogenated C₄-C₂₀ carbocyclic group, a C₁-C₂₀ heterocyclic group, or a halogenated C₁-C₂₀ heterocyclic group; two adjacent groups selected from among R₂₃, R₂₄, and R₂₅ are linked to form a group represented by Formula 7A below; and
the unselected rest of R₂₃, R₂₄ and R₂₅ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbocyclic group, a halogenated C₄-C₂₀ carbocyclic group, a C₁-C₂₀ heterocyclic group, or a halogenated C₁-C₂₀ heterocyclic group,

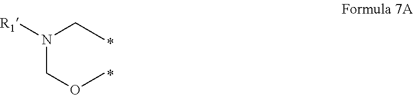

wherein, in Formula 7A, R₁′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and
* denotes the sites at which the two adjacent groups selected from among R₂₀, R₂₁ and R₂₂ of Formula 7 are linked, and the two adjacent groups selected from R₂₃, R₂₄ and R₂₅ of Formula 7 are linked.

According to another aspect, there is provided a composite that is a polymerization product of the above-described composition.

According to another aspect, there is provided a composite membrane for a fuel cell that includes the above-described composite.

According to another aspect, there is provided an electrode for a fuel cell, the electrode including the above-described composition or a composite that is a polymerization product of the composition.

According to another aspect, there is provided a fuel cell including: a cathode; an anode; and an electrolyte membrane disposed between the cathode and the anode, wherein the electrolyte membrane includes the above-described composite.

According to another aspect, there is provided a method of preparing an electrolyte membrane for a fuel cell, the method including:

mixing the compound represented by Formula 1 above, an azole-based polymer, and at least one of compounds represented by Formulae 2-7 above to obtain a composition; coating the composition to obtain a coated composition; and
thermally treating the coated composition to obtain the electrolyte membrane that includes a composite as a polymerization product of the compound represented by Formula 1, the azole-based polymer, and the at least one of compounds represented by Formulae 2-7.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective exploded view of a fuel cell according to an embodiment of the present disclosure;

FIG. 2 is a cross-sectional diagram of a membrane-electrode assembly (“MEA”) forming the fuel cell of FIG. 1;

FIGS. 3A to 3C present scanning electron microscopic (“SEM”) images of electrolyte membranes of Examples 1-3;

FIG. 4 is a graph of elongation strength (megapascal, MPa) versus content of Sn_{0.9}In_{0.1}P₂O₇ (“SIPO”) (parts by weight) in the electrolyte membranes of Examples 1-3 and Reference Example 1;

FIG. 5 is a graph of elongation at break (percent, %) versus content of SIPO (parts by weight) in the electrolyte membranes of Examples 1-3 and Reference Example 1;

FIG. 6 is a graph of conductivity (milliSiemens per centimeter, mS/cm) versus temperature (degrees centigrade, ° C.) in the electrolyte membranes of Examples 1-3 and Reference Example 1;

FIG. 7 is a graph of voltage (volts, V) versus current density (milliAmperes per square centimeter, mA/cm²) representing cell performance of fuel cells that include the electrolyte membranes of Example 1 and Reference Example 1, respectively;

FIG. 8 is a graph representing results of a durability evaluation test (Evaluation Example 5) on the fuel cells that include the electrolyte membranes of Example 1 and Reference Example 1, respectively in Evaluation Example 5;

FIG. 9 is ¹³C cross-polarization and magic angle spinning (CR/MAS) NMR spectra of samples, including a composite of Example 1; and

FIGS. 10 and 11 are ³¹P high-power decoupled (HP-DEC) NMR spectra of the samples.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

According to an embodiment of the present disclosure, there is provided a composition that includes a compound represented by Formula 1 below, an azole-based polymer, and at least one of compounds represented by Formulae 2-7:

M¹₁₋ₐM²ₐPₓO_{y} Formula 1

wherein, in Formula 1, M¹ is a tetravalent element;
M² is at least one selected from the group including a monovalent element, a divalent element, and a trivalent element;
0≦a<1;
x is a number from 1.5 to 3.5; and
y is a number from 5 to 13.

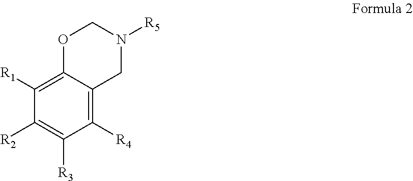

In Formula 2, R₁, R₂, R₃ and R₄ are each independently a hydrogen atom, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₂-C₂₀ heteroaryl group, a substituted or unsubstituted C₂-C₂₀ heteroaryloxy group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, a halogen atom, a hydroxy group, or a cyano group; and
R₅ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group.

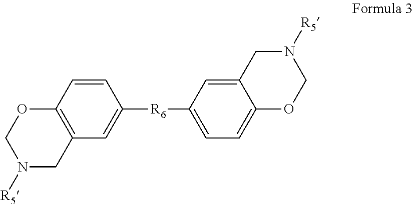

In Formula 3, R₅′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and
R₆ is a substituted or unsubstituted C₁-C₂₀ alkylene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₂-C₂₀ heteroarylene group, —C(═O)—, or —SO₂—.

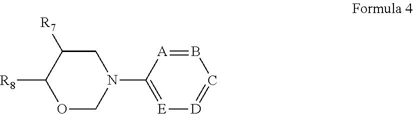

In Formula 4, A, B, C, D and E are all carbon; or one or two of A, B, C, D and E is nitrogen and the others are carbon; and
R₇ and R₈ are linked to form a ring, wherein the ring is a C₆-C₁₀ cycloalkyl group, a C₃-C₁₀ heteroaryl group, a fused C₃-C₁₀ heteroaryl group, a C₃-C₁₀ heterocyclic group, or a fused C₃-C₁₀ heterocyclic group.

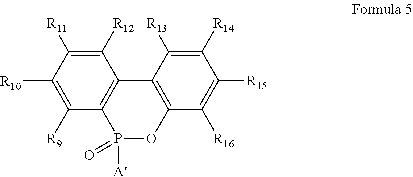

In Formula 5, A′ is a substituted or unsubstituted C₁-C₂₀ heterocyclic group, a substituted or unsubstituted C₄-C₂₀ cycloalkyl group, or a substituted or unsubstituted C₁-C₂₀ alkyl group; and
R₉ to R₁₆ are each independently a hydrogen atom, a C₁-C₂₀ alkyl group, a C₁-C₂₀ alkoxy group, a C₆-C₂₀ aryl group, a C₆-C₂₀ aryloxy group, a C₁-C₂₀ heteroaryl group, a C₁-C₂₀ heteroaryloxy group, a C₄-C₂₀ cycloalkyl group, a C₁-C₂₀ heterocyclic group, a halogen atom, a cyano group, or a hydroxy group.

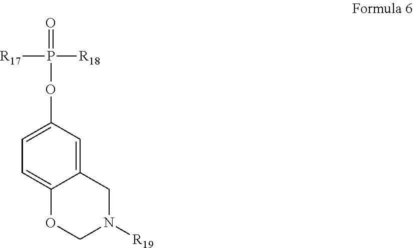

In Formula 6, R₁₇ and R₁₈ are each independently a C₁-C₂₀ alkyl group, a C₁-C₂₀ alkoxy group, a C₆-C₂₀ aryl group, a C₆-C₂₀ aryloxy group, or a group represented by Formula 6A below.

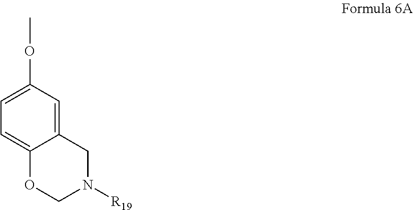

In Formulae 6 and 6A, R₁₉ and R₁₉′ are each independently a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ cycloalkyl group, a halogenated C₄-C₂₀ cycloalkyl group, a C₁-C₂₀ heterocyclic group, or a halogenated C₁-C₂₀ heterocyclic group.

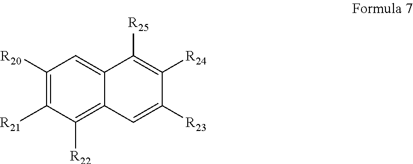

In Formula 7, two adjacent groups selected from R₂₀, R₂₁, and R₂₂ are linked to form a group represented by Formula 7A below;
the unselected rest of R₂₀, R₂₁ and R₂₂ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbocyclic group, a halogenated C₄-C₂₀ carbocyclic group, a C₁-C₂₀ heterocyclic group, or a halogenated C₁-C₂₀ heterocyclic group; two adjacent groups selected from R₂₃, R₂₄, and R₂₅ are linked to form a group represented by Formula 7A below; and
the unselected rest of R₂₃, R₂₄ and R₂₅ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbocyclic group, a halogenated C₄-C₂₀ carbocyclic group, a C₁-C₂₀ heterocyclic group, or a halogenated C₁-C₂₀ heterocyclic group.

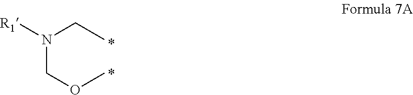

In Formula 7A, R₁′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and
* denotes the sites at which the two adjacent groups selected from among R₂₀, R₂₁ and R₂₂ of Formula 7 are linked, and the two adjacent groups selected from among R₂₃, R₂₄ and R₂₅ of Formula 7 are linked.
In Formula 7A, R₁ is selected from the groups represented by Formulae 7B.

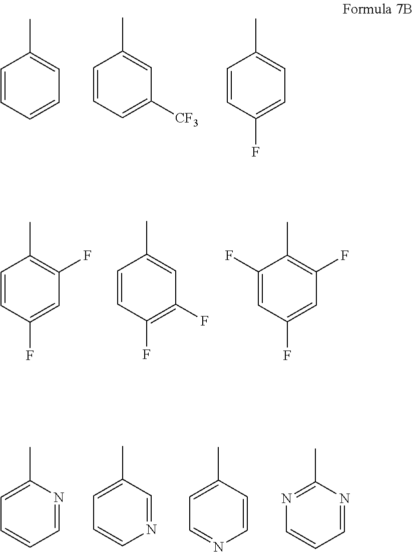

According to another embodiment of the present disclosure, there is provided a composite that is a polymerization product of the composition described above.

According to another embodiment of the present disclosure, there is provided an electrolyte membrane for fuel cells that includes the composite, which is a polymerization product of the compound of Formula 1 above, the azole-based polymer, and the at least one of compounds of Formulae 2-7 above.

The composite may be a product of complexation of a polymer that is a polymerization product of the compound of Formula 1, which is an inorganic proton conductor, the azole-based polymer, and the at least one of compounds of Formulae 2-7. When an electrolyte membrane is prepared from the composite, the electrolyte membrane may have improved mechanical strength, and improved conductivity due to suppressed leakage of a phosphoric acid-based material therefrom. Thus, use of the electrolyte membrane may ensure manufacture of a fuel cell with improved long-term durability.

In the electrolyte membrane with the foregoing composition, interaction of protons in the compound of Formula 1 with the phosphoric acid-based material may furnish a fuel cell with improved cell performance at high temperatures.

An amount of the compound of Formula 1 in the composition may be from about 1 part to about 150 parts by weight, and in some embodiments, from about 5 parts to about 45 parts by weight, based on 100 parts by weight of the azole-based polymer and the at least one selected from compounds of Formulae 2-7.

When the amount of the compound of Formula 1 is within the foregoing ranges, dispersibility of the compound of Formula 1 in the composition and electrolyte membrane may be improved, and an electrolyte membrane with improved conductivity and durability without a decrease in mechanical stability may be obtained.

The compound of Formula 1 in the composition may have a particle diameter of about 30 nanometers (“nm”) to about 300 nm, in some embodiments, about 50 nm to about 250 nm, and in some other embodiments may be about 200 nm.

An amount of the at least one of compounds represented by Formulae 2-7 may be from about 10 parts to about 90 parts by weight, and in some embodiments may be from about 30 parts to about 70 parts by weight, based on 100 parts by weight of the azole-based polymer and the at least one selected from compounds of Formulae 2-7.

The composition may further include a phosphoric acid-based material.

The amount of the phosphoric acid-based material may be from about 270 parts to about 500 parts by weight based on 100 parts by weight of the compound of Formula 1. When the amount of the phosphoric acid-based material is within the foregoing range, an electrolyte membrane manufactured from the composition may have high proton conductivity even with a small doping amount of the phosphoric acid-based material.

In Formula 1 above, M¹ is a tetravalent element. For example, M¹ may be at least one selected from the group including tin (Sn), zirconium (Zr), tungsten (W), silicon (Si), molybdenum (Mo), and titanium (Ti).

In Formula 1 above, M² is at least one selected from the group including a monovalent element, a divalent element, and a trivalent element.

For example, M² may be at least one selected from the group including lithium (Li), sodium (Na), potassium (K), cesium (Cs), beryllium (Be), magnesium (Mg), calcium (Ca), strontium (Sr), barium (Ba), indium (In), aluminum (Al), and antimony (Sb).

In Formula 1 above, if a is greater than 0, M¹ may be partially substituted with M².

In Formula 1, a may be a number from 0.01 to 0.7.

In some embodiments, a may be a number from 0.05 to 0.5, and in some other embodiments, a may be a number from 0.1 to 0.4.

In Formula 1 above, x may be 2, and y may be 7.

In Formula 1, M¹ may be tin (Sn), and M² may be indium (In). In an embodiment, the compound of Formula 1 may be Sn₁₋ₐAlₐP₂O₇ where a is from 0.05 to 0.5.

Examples of the compound of Formula 1 are Sn_{0.9}In_{0.1}P₂O₇, Sn_{0.95}Al_{0.05}P₂O₇, Ti_{0.9}In_{0.1}P₂O₇, Ti_{0.95}Al_{0.05}P₂O₇, Zr_{0.9}In_{0.1}P₂O₇, Zr_{0.95}Al_{0.05}P₂O₇, W_{0.9}In_{0.1}P₂O₇, W_{0.95}Al_{0.05}P₂O₇, Sn_{0.7}Li_{0.3}P₂O₇, Sn_{0.95}Li_{0.05}P₂O₇, Sn_{0.9}Li_{0.1}P₂O₇, Sn_{0.8}Li_{0.2}P₂O₇, Sn_{0.6}Li_{0.4}P₂O₇, Sn_{0.5}Li_{0.5}P₂O₇, Sn_{0.7}Na_{0.3}P₂O₇, Sn_{0.7}K_{0.3}P₂O₇, Sn_{0.7}Cs_{0.3}P₂O₇, Zr_{0.9}Li_{0.1}P₂O₇, Ti_{0.9}Li_{0.1}P₂O₇, Si_{0.9}Li_{0.1}P₂O₇, Mo_{0.9}Li_{0.1}P₂O₇, W_{0.9}Li_{0.1}P₂O₇, Sn_{0.7}Mg_{0.3}P₂O₇, Sn_{0.95}Mg_{0.05}P₂O₇, Sn_{0.9}Mg_{0.1}P₂O₇, Sn_{0.8}Mg_{0.2}P₂O₇, Sn_{0.6}Mg_{0.4}P₂O₇, Sn_{0.5}Mg_{0.5}P₂O₇, Sn_{0.7}Ca_{0.3}P₂O₇, Sn_{0.7}Sr_{0.3}P₂O₇, Sn_{0.7}Ba_{0.3}P₂O₇, Zr_{0.9}Mg_{0.1}P₂O₇, Ti_{0.9}Mg_{0.1}P₂O₇, Si_{0.9}Mg_{0.1}P₂O₇, Mo_{0.9}Mg_{0.1}P₂O₇, W_{0.9}Mg_{0.1}P₂O₇, Zr_{0.7}Mg_{0.3}P₂O₇, Ti_{0.7}Mg_{0.3}P₂O₇, Si_{0.7}Mg_{0.3}P₂O₇, Mo_{0.7}Mg_{0.3}P₂O₇, and W_{0.7}Mg_{0.3}P₂O₇.

The compound of Formula 1 may be a tin phosphate compound wherein M¹ is tin (Sn). Due to its dense structure, a tin phosphate compound may be suitable for forming a proton path.

The tin phosphate compound may be a compound of Formula 3 wherein M¹ for Sn is partially substituted with trivalent indium (In) or aluminum (Al) ions. In the compound with M¹ for Sn that is partially substituted with trivalent ions, the substitution may be facilitated due to a similar diameter of the In or Al ions and an ionic diameter of Sn. Defects from the substitution may help dissolution of protons. Therefore, when such a compound is used, an electrolyte membrane having high conductivity even at a low doping level of phosphoric acid may be manufactured.

The azole-based polymer is a polymer, a repeating unit of which includes at least one aryl ring having at least one nitrogen atom.

The aryl ring may be a five-membered or six-membered atom ring with one to three nitrogen atoms that may be fused to another ring, for example, another aryl ring or heteroaryl ring. In this regard, the nitrogen atoms may be substituted with oxygen, phosphorous and/or sulfur atom. Examples of the aryl ring are phenyl, naphthyl, hexahydroindyl, indanyl, and tetrahydronaphthyl.

The azole-based polymer may have at least one amino group in the repeating unit as described above. In this regard, the at least one amino group may be a primary, secondary or tertiary amino group which is either part of the aryl ring or part of a substituent of the aryl unit.

The term “amino group” indicates a group wherein a nitrogen atom covalently bonded to at least one carbon or hetero atom. The amino group may refer to, for example, —NH₂ and substituted moieties.

The term “amino group” also refers to an “alkylamino group” with nitrogen bound to at least one additional alkyl group, and “arylamino” and “diarylamino” groups with at least one or two nitrogen atoms bound to a selected aryl group.

Methods of preparing an azole-based polymer and a polymer film including the azole-based polymer are disclosed in prior art, for example in US 2005/256296A.

Examples of the azole-based polymer are azole-based polymers including azole units represented by Formulae 8 to 21.

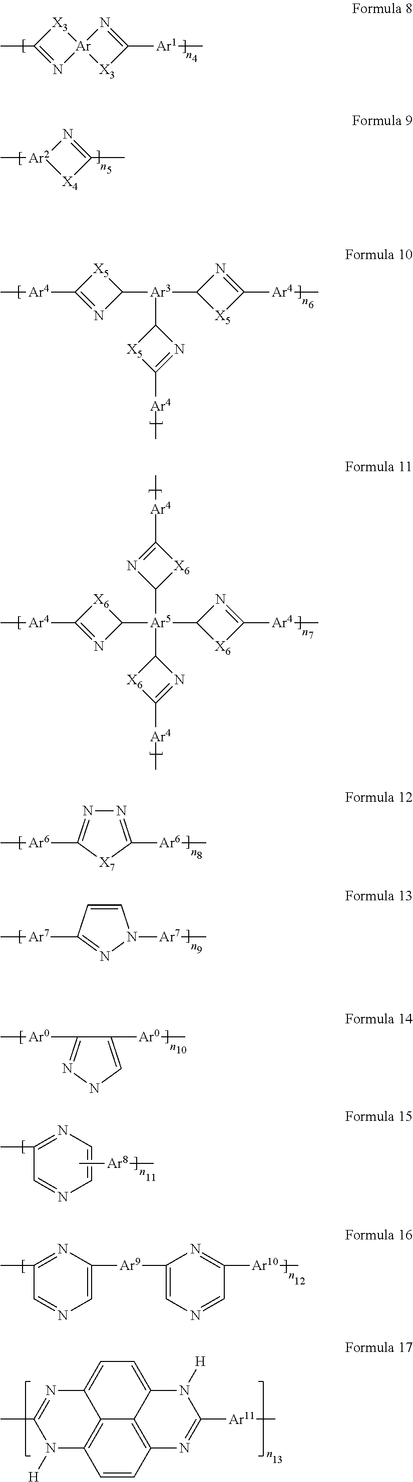

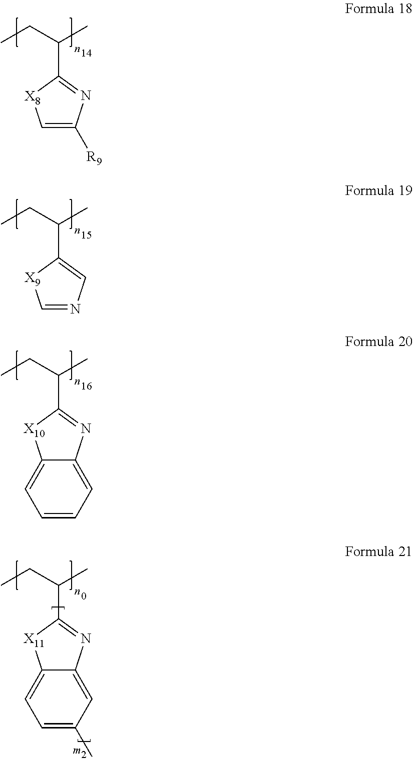

wherein in Formulae 8 to 21, Ar⁰ may be identical to or different from each other, and may be a monocyclic or polycyclic C₆-C₂₀ aromatic group or a C₂-C₂₀ heteroaromatic group;
Ar may be identical to or different from each other, and may be a monocyclic or polycyclic C₆-C₂₀ aromatic group or a C₂-C₂₀ heteroaromatic group;
Ar¹ may be identical to or different from each other, and may be a monocyclic or polycyclic C₆-C₂₀ aromatic group or a C₂-C₂₀ heteroaromatic group;
Ar² may be identical to or different from each other, and may be a or trivalent monocyclic or polycyclic C₆-C₂₀ aromatic group or a C₂-C₂₀ heteroaromatic group;
Ar³ may be identical to or different from each other, and may be a monocyclic or polycyclic C₆-C₂₀ aromatic group or a C₂-C₂₀ heteroaromatic group;
Ar⁴ may be identical to or different from each other, and may be a monocyclic or polycyclic C₆-C₂₀ aromatic group or a C₂-C₂₀ heteroaromatic group;
Ar⁵ may be identical to or different from each other, and may be a monocyclic or polycyclic C₆-C₂₀ aromatic group or a C₂-C₂₀ heteroaromatic group;
Ar⁶ may be identical to or different from each other, and may be a monocyclic or polycyclic C₆-C₂₀ aromatic group or a C₂-C₂₀ heteroaromatic group;
Ar⁷ may be identical to or different from each other, and may be a monocyclic or polycyclic C₆-C₂₀ aromatic group or a C₂-C₂₀ heteroaromatic group;
Ar⁸ may be identical to or different from each other, and may be a monocyclic or polycyclic C₆-C₂₀ aromatic group or a C₂-C₂₀ heteroaromatic group;
Ar⁹ may be identical to or different from each other, and may be a monocyclic or polycyclic C₆-C₂₀ aromatic group or a C₂-C₂₀ heteroaromatic group;
Ar¹⁰ may be identical to or different from each other, and may be a monocyclic or polycyclic C₆-C₂₀ aromatic group or a C₂-C₂₀ heteroaromatic group;
Ar¹¹ may be identical to or different from each other, and may be a monocyclic or polycyclic C₆-C₂₀ aromatic group or a C₂-C₂₀ heteroaromatic group;
X₃ to X₁₁ may be identical to or different from each other, and may be an oxygen atom, a sulfur atom or —N(R′)—; and R′ may be a hydrogen atom, a C₁-C₂₀ alkyl group, a C₁-C₂₀ alkoxy group or a C₆-C₂₀ aryl group;
R₉ may be identical to or different from each other, and may be a hydrogen atom, a C₁-C₂₀ alkyl group or a C₆-C₂₀ aryl group; and
n₀, n₄ to n₁₆, and m₂ may be each independently an integer of 10 or greater, and in some embodiments, may be each an integer of 100 or greater, and in some other embodiments, may be each an integer of 100 to 100,000.

Examples of the aromatic or heteroaromatic group are benzene, naphthalene, biphenyl, diphenylether, diphenylmethane, diphenyldimethylmethane, bisphenone, diphenylsulfone, quinoline, pyridine, bipyridine, pyridazine, pyrimidine, pyrazine, triazine, tetrazine, pyrrole, pyrazole, anthracene, benzopyrrole, benzotriazole, benzoxathiazole, benzoxadiazole, benzopyridine, benzopyrazine, benzopyrazidine, benzopyrimidine, benzotriazine, indolizine, quinolizine, pyridopyridine, imidazopyrimidine, pyrazinopyrimidine, carbazole, aziridine, phenazine, benzoquinoline, phenoxazine, phenothiazine, benzopteridine, phenanthroline and phenanthrene, wherein the foregoing aryl or heteroaryl groups may have a substituent.

Ar¹, Ar⁴, Ar⁶, Ar⁷, Ar⁸, Ar⁹, Ar¹⁰, and Ar¹¹ defined above may have any substitution pattern. For example, if Ar¹, Ar⁴, Ar⁶, Ar⁷, Ar⁸, Ar⁹, Ar¹⁰, and Ar¹¹ are phenylene, Ar¹, Ar⁴, Ar⁶, Ar⁷, Ar⁸, Ar⁹, Ar¹⁰ and Ar¹¹ may be ortho-phenylene, meta-phenylene or para-phenylene.

The alkyl group may be a C₁-C₄ short-chain alkyl group, such as methyl, ethyl, n-propyl, i-propyl or t-butyl. The aryl group may, for example, be a phenyl group or a naphthyl group.

Examples of the substituent are a halogen atom, such as fluorine, an amino group, a hydroxyl group, and a short-chain alkyl group, such as methyl or ethyl.

Examples of the azole-based polymer are polyimidazole, polybenzothiazole, polybenzoxazole, polyoxadiazole, polyquinoxaline, polythiadiazole, polypyridine, polypyrimidine, and polytetrazapyrene.

The azole-based polymer may be a copolymer or blend including at least two units selected from Formulae 8 to 21 above. The azole-based polymer may be a block copolymer (for example, di-block or tri-block copolymer), a random copolymer, a periodic copolymer or an alternating copolymer including at least two units selected from Formulae 8 to 21.

In some embodiments, the azole-based polymer may include at least one unit of Formulae 8 and 9.

Examples of the azole-based polymer are polymers represented by Formulae 22 to 48 below:

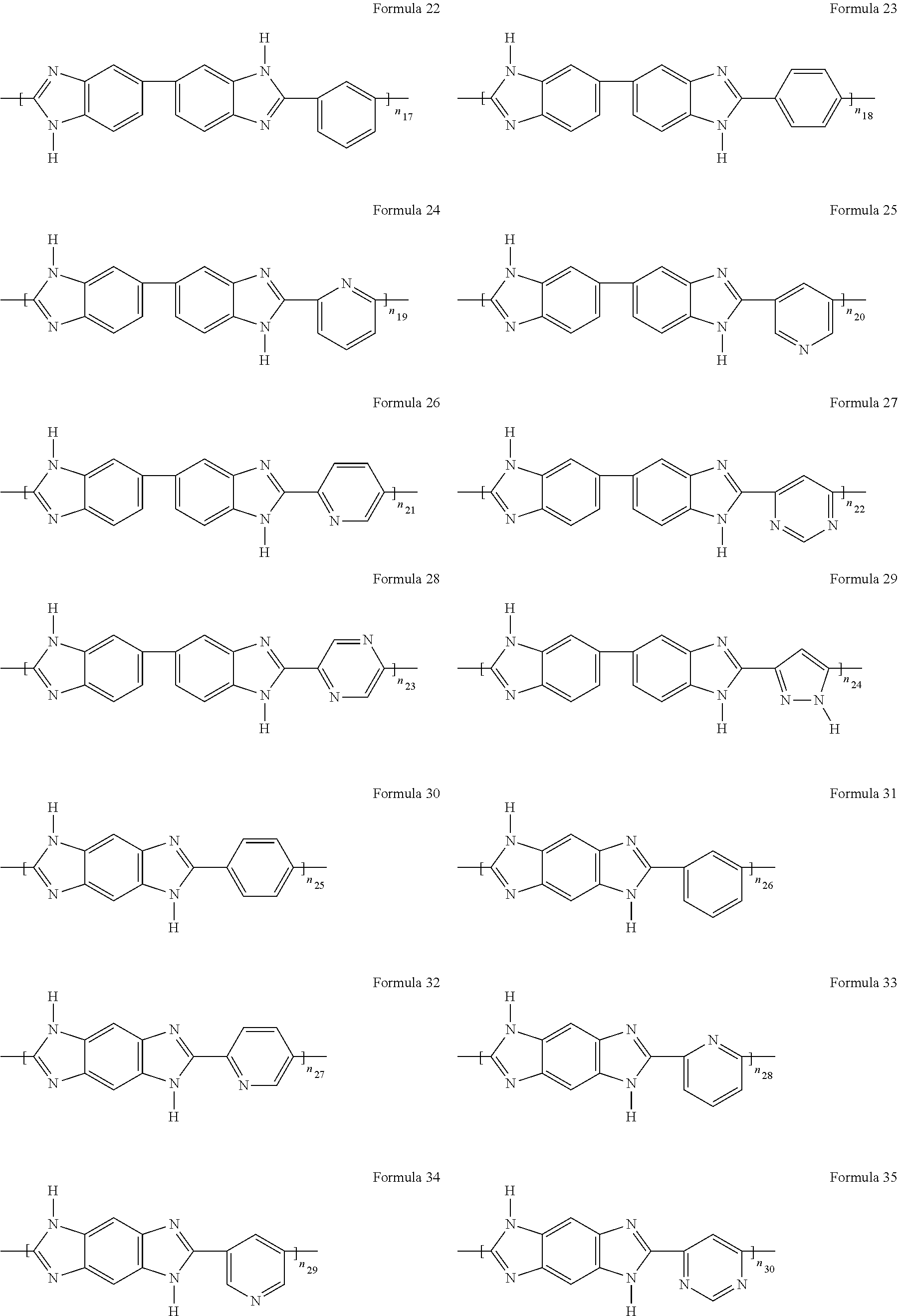

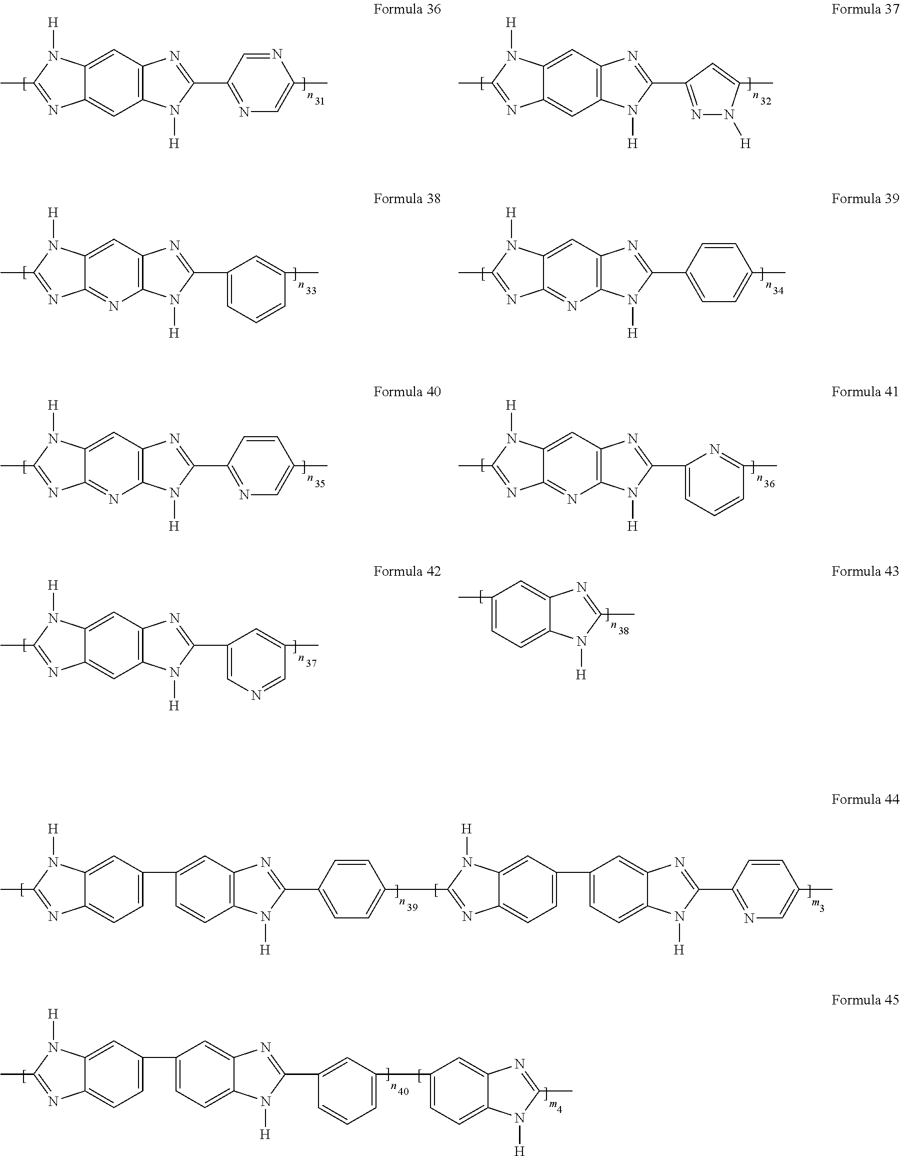

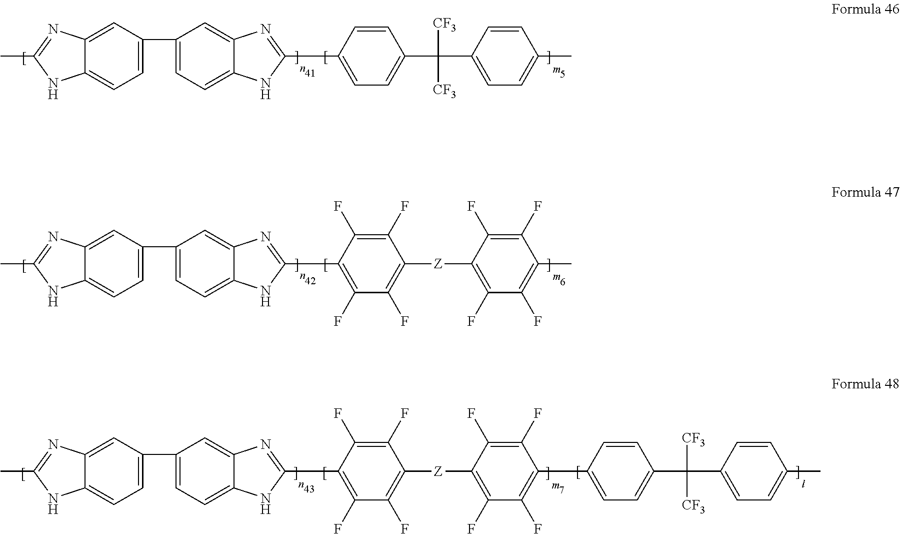

wherein in Formulae 22 to 48, I, n₁₇ to n₄₃, and m₃ to m₇ may be each an integer of 10 or greater, and in some embodiments, may be an integer of 100 or greater;
z may be a chemical bond, —(CH₂)_{S}—, —C(═O)—, —SO₂—, —C(CH₃)₂—, or —C(CF₃)₂—; and s may be an integer of 1 to 5.

The azole-based polymer may be a compound including m-polybenzimidazole (“PBI”) represented by Formula 49 below, or a compound including p-PBI represented by Formula 50 below.

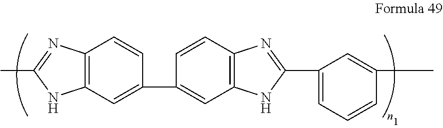

wherein in Formula 49, n₁ is an integer of 10 or greater;

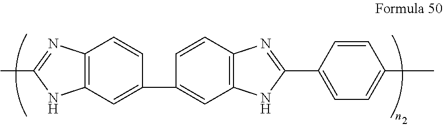

wherein in Formula 50, n₂ is an integer of 10 or greater.

The polymers of Formulae 49 and 50 may each have a number average molecular weight of 1,000,000 Daltons (“Da”) or less, in some embodiments 500,000 Da or less, and in some other embodiments, from 1,000 to 500,000 Da.

For example, the azole-based polymer may be a benzimidazole-based polymer represented by Formula 51 below.

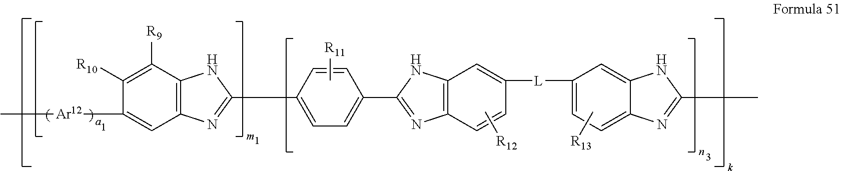

wherein in Formula 51,
R₉ and R₁₀ are each independently a hydrogen atom, an unsubstituted or substituted C₁-C₂₀ alkyl group, a unsubstituted or substituted C₁-C₂₀ alkoxy group, a unsubstituted or substituted C₆-C₂₀ aryl group, a unsubstituted or substituted C₆-C₂₀ aryloxy group, a unsubstituted or substituted C₃-C₂₀ heteroaryl group, or a unsubstituted or substituted C₃-C₂₀ heteroaryloxy group, wherein R₉ and R₁₀ may be linked to form a C₄-C₂₀ carbon ring or a C₃-C₂₀ hetero ring;
Ar¹² is a substituted or unsubstituted C₆-C₂₀ arylene group or a substituted or unsubstituted C₃-C₂₀ heteroarylene group;
R₁₁ to R₁₃ are each independently a single or a multi-substituted substituent selected from the group including a hydrogen atom, a substituted or unsubstituted C₁-C₂₀ alkyl group, a substituted or unsubstituted C₁-C₂₀ alkoxy group, a substituted or unsubstituted C₆-C₂₀ aryl group, a substituted or unsubstituted C₆-C₂₀ aryloxy group, a substituted or unsubstituted C₆-C₂₀ heteroaryl group, and a substituted or unsubstituted C₃-C₂₀ heteroaryloxy group;
L represents a linker;
m₁ is from 0.01 to 1;
a₁ is 0 or 1;
n₃ is a number from 0 to 0.99; and
k is a number from 10 to 250.

The benzimidazole-based polymer may include a compound represented by Formula 52 below or a compound represented by Formula 53 below:

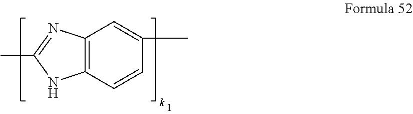

wherein in Formula 52, k₁ represents a degree of polymerization and is a number from 10 to 300.

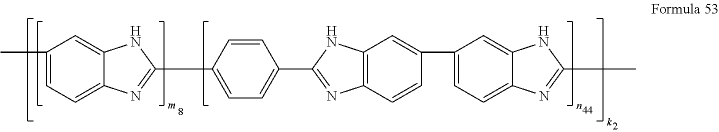

wherein in Formula 53,
m₈ is a number from 0.01 to 1, and in some embodiments, may be a number from 1 or to a number from 0.1 to 0.9;
n₄₄ is a number from 0 to 0.99, and in some embodiments, may be 0 or a number from 0.1 to 0.9; and K₂ may be a number from 10 to 250.

Hereinafter, the compounds represented by Formulae 2 to 7 above will be described in greater detail.

Examples of the compound of Formula 2 are compounds represented by Formulae 54 to 102.

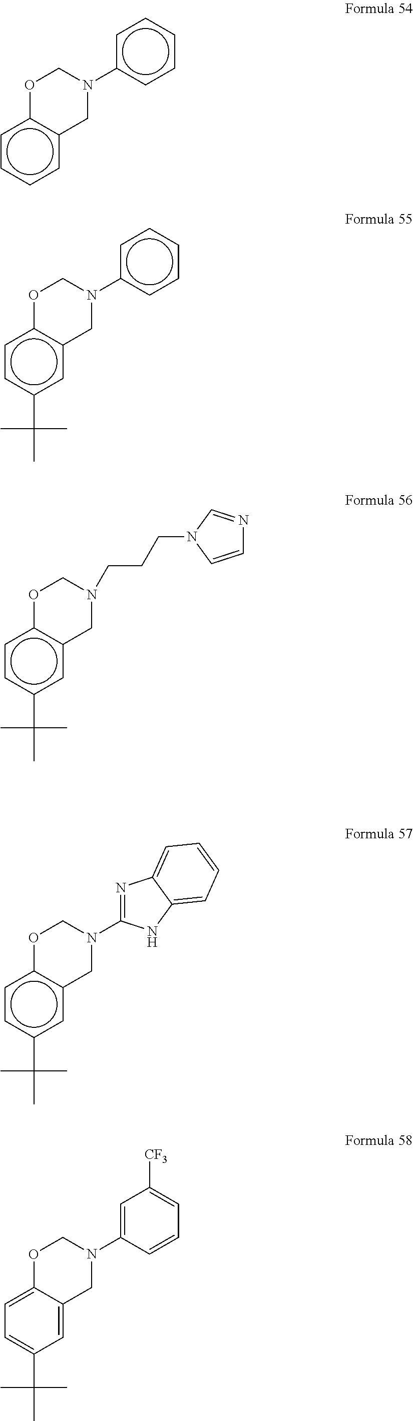

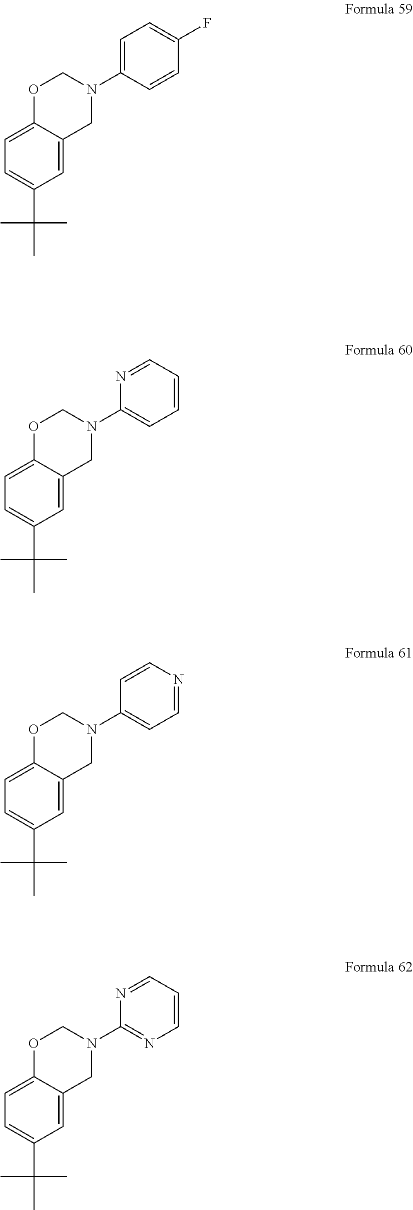 [SMILES: CC(C)(C)c1ccc2c(c1)CN(c1ccc(F)cc1)CO2 ; CC(C)(C)c1ccc2c(c1)CN(c1ccccn1)CO2 ; CC(C)(C)c1ccc2c(c1)CN(c1ccncc1)CO2 ; CC(C)(C)c1ccc2c(c1)CN(c1ncccn1)CO2]

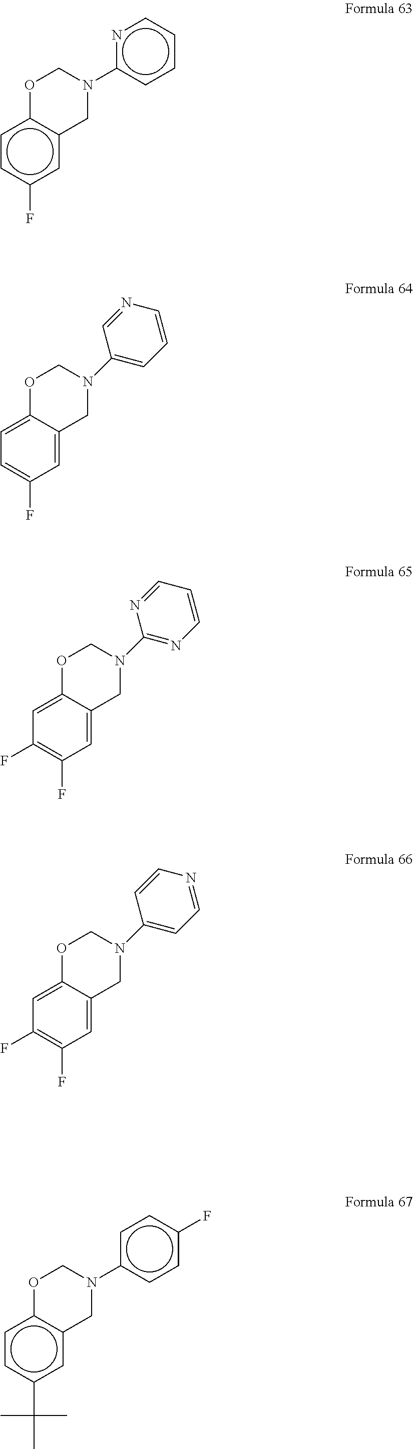

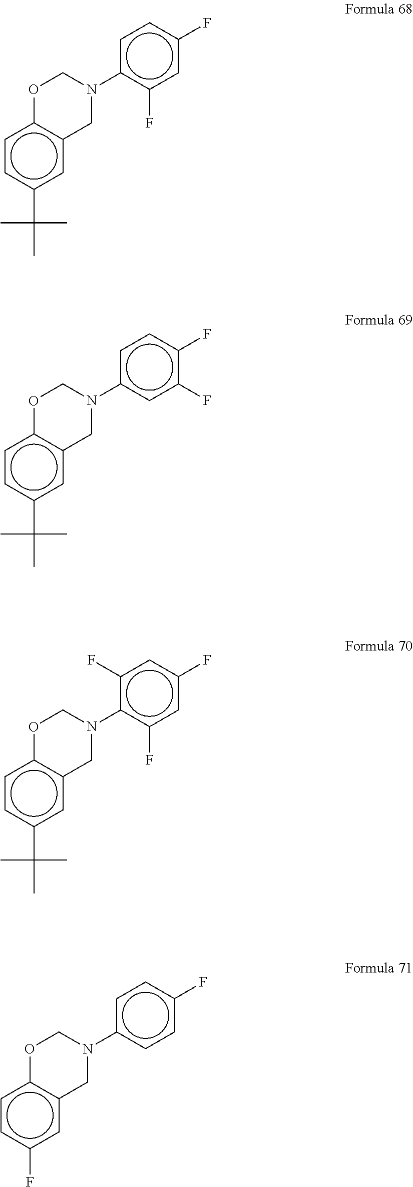

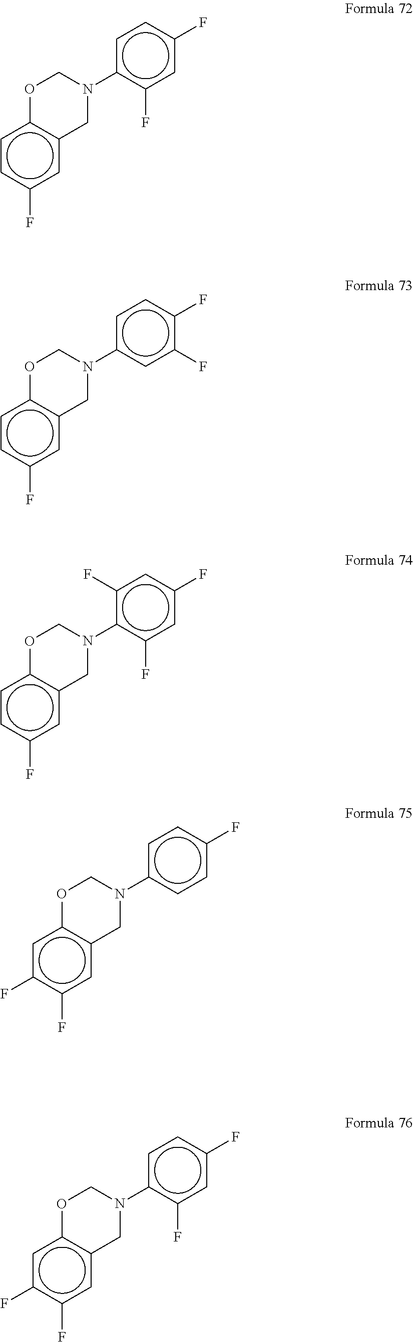

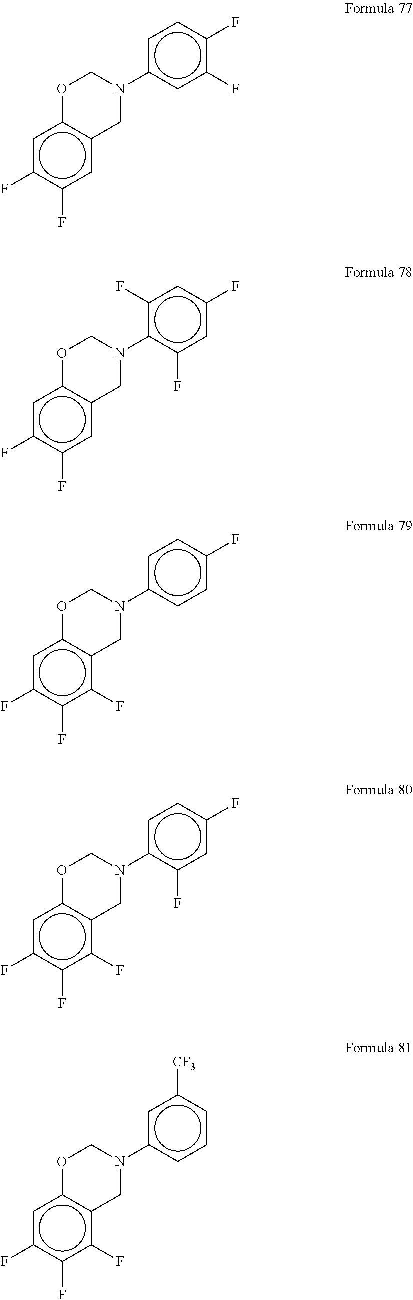

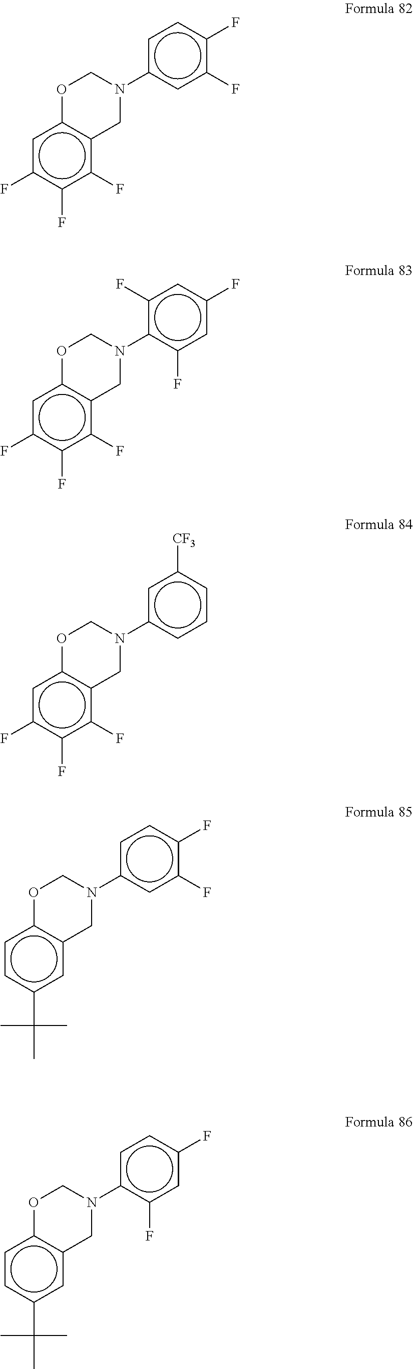

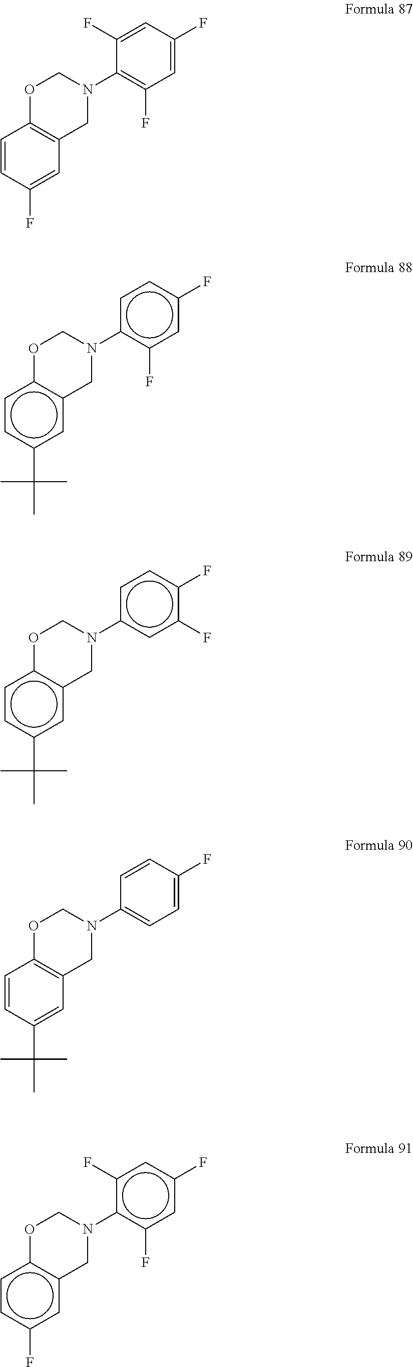

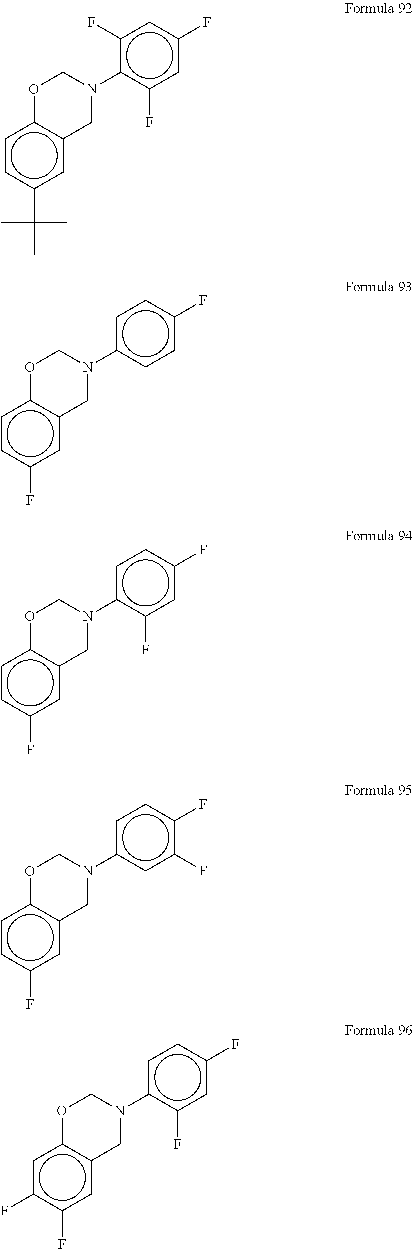

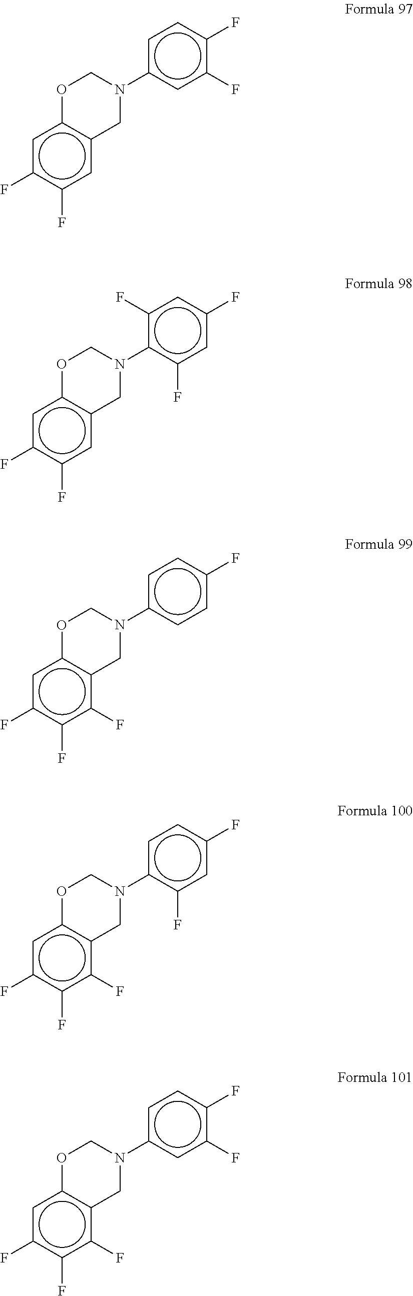

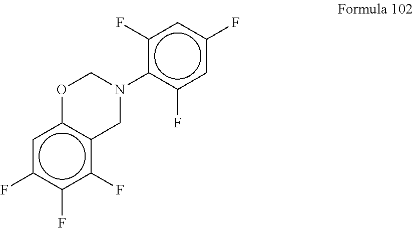

Examples of the compound of Formula 3 are compounds represented by Formula 103 Formula 107.

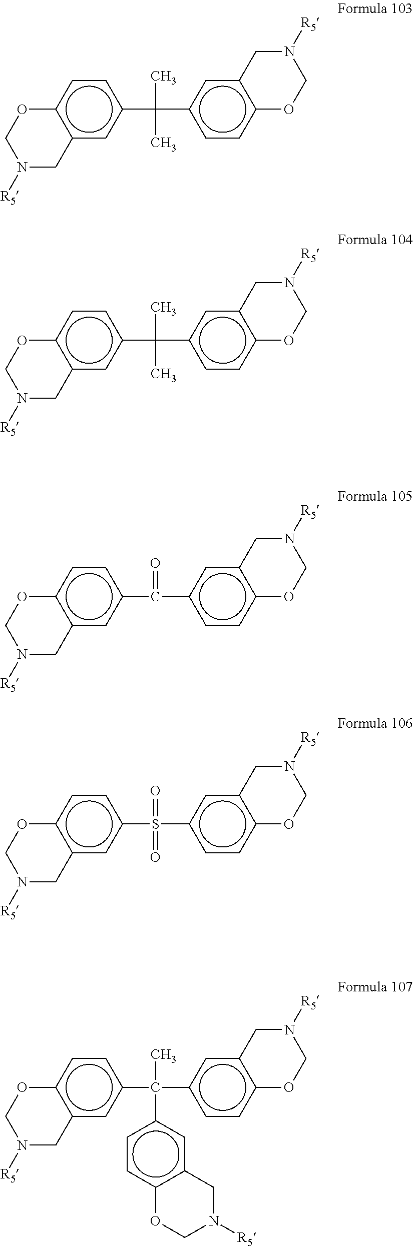

wherein in Formulae 103 to 107, R₅′ is —CH₂—CH═CH₂ or groups represented by Formulae 108 below.

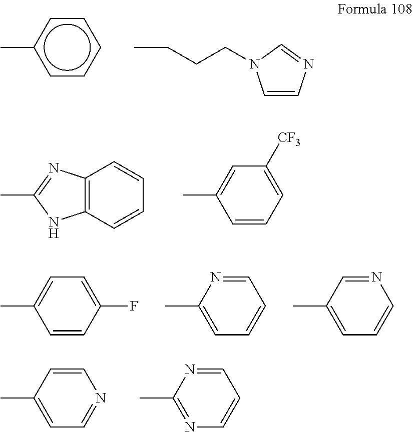

Examples of the compound of Formula 4 are compounds represented by Formulae 109 to 116.

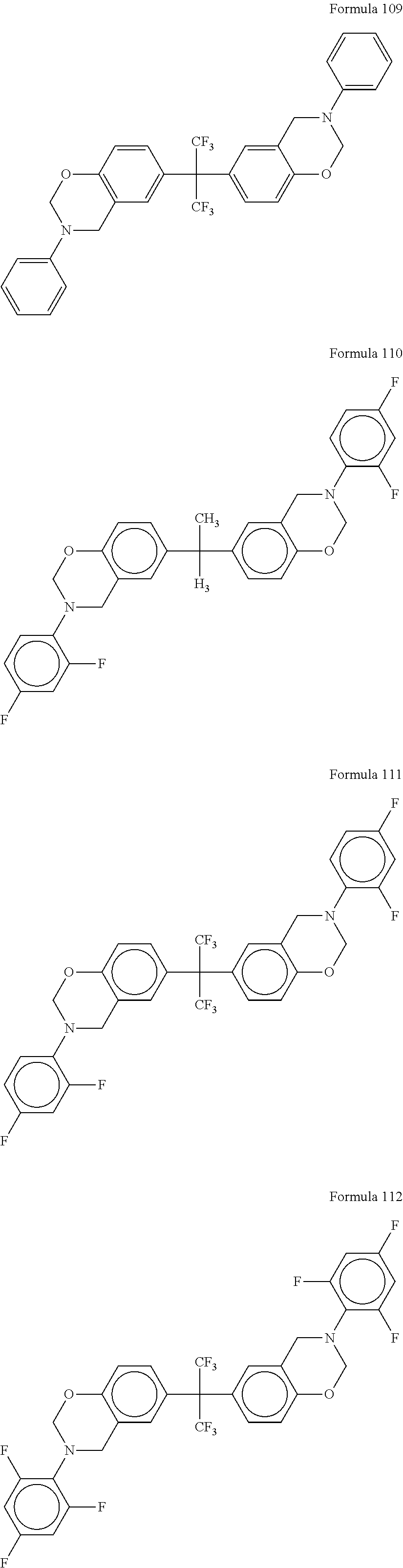

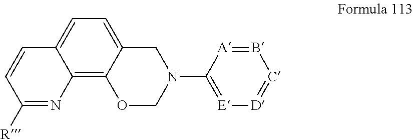

wherein in Formula 113, R′″ is a hydrogen atom or a C₁-C₁₀ alkyl group.

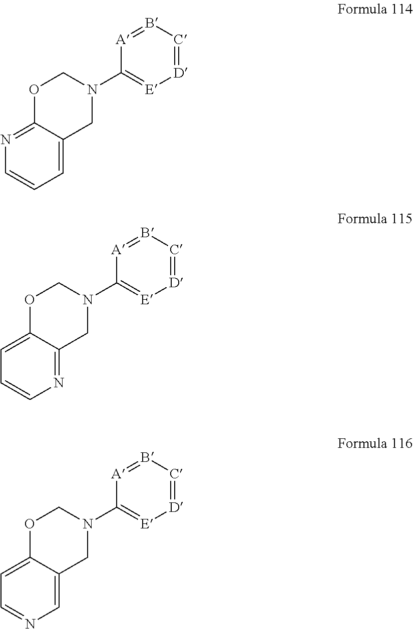

wherein in Formulas 113 to 116,

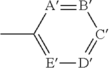

is selected from groups presented by Formulae 117 below.

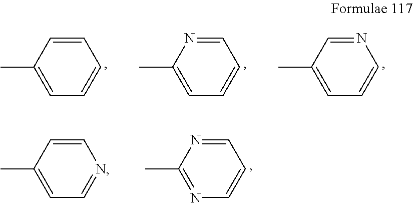

Examples of the compound of Formula 4 are compounds represented by Formulae 118 to 138 below:

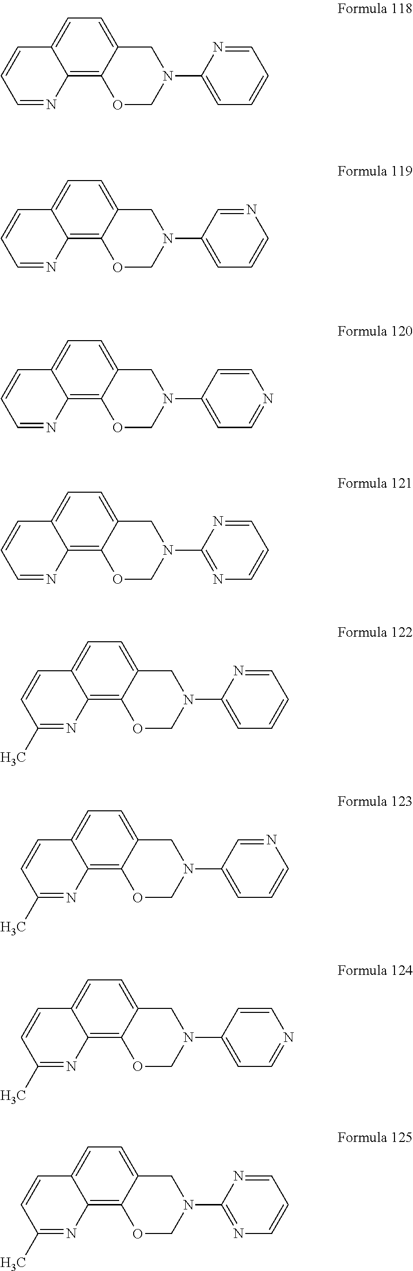

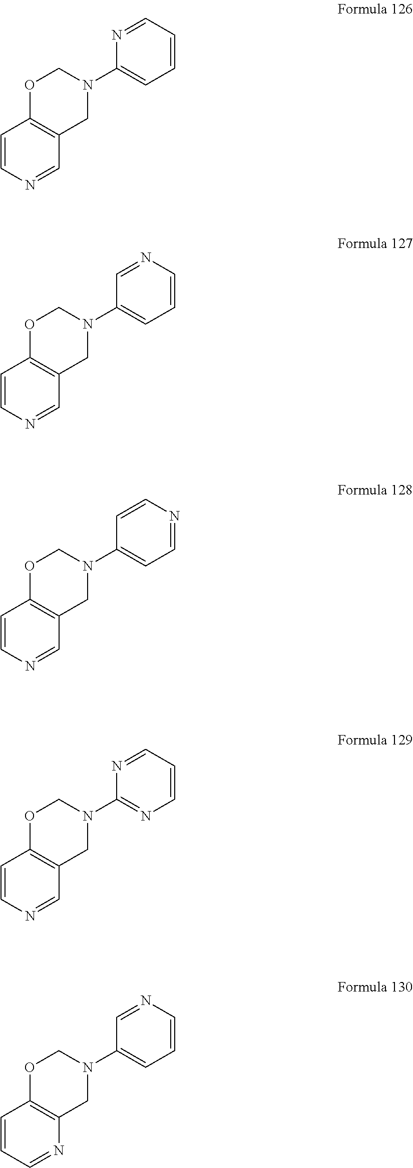 [SMILES: c1ccc(N2COc3ccncc3C2)nc1 ; c1cncc(N2COc3ccncc3C2)c1 ; c1cc(N2COc3ccncc3C2)ccn1 ; c1cnc(N2COc3ccncc3C2)nc1 ; c1cncc(N2COc3cccnc3C2)c1]

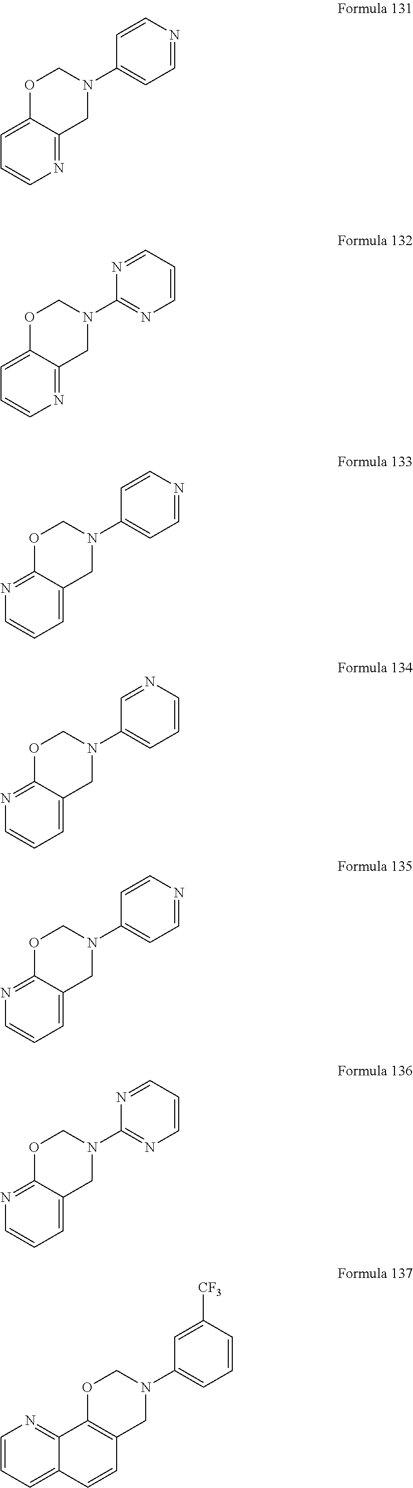

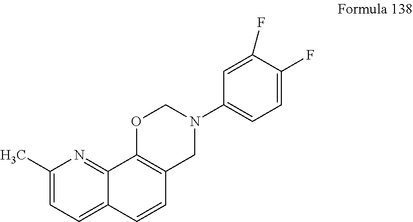 [SMILES: Cc1ccc2ccc3c(c2n1)OCN(c1ccc(F)c(F)c1)C3]

In the compound of Formula 5, A′ may be a group represented by Formula 139 or 140 below:

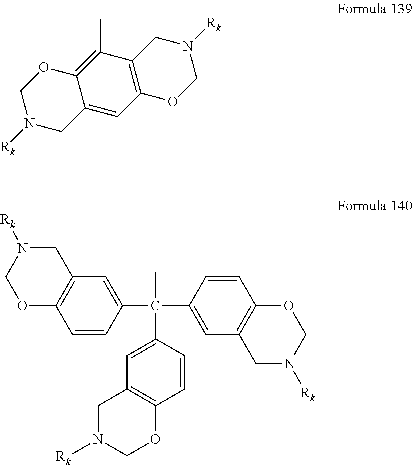

wherein in Formulae 139 and 140, Rₖ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbocyclic group, a halogenated C₄-C₂₀ carbocyclic group, a C₁-C₂₀ heterocyclic group or a halogenated C₁-C₂₀ heterocyclic group.

Examples of the compound of Formula 5 are compounds represented by Formulae 141 and 142 below:

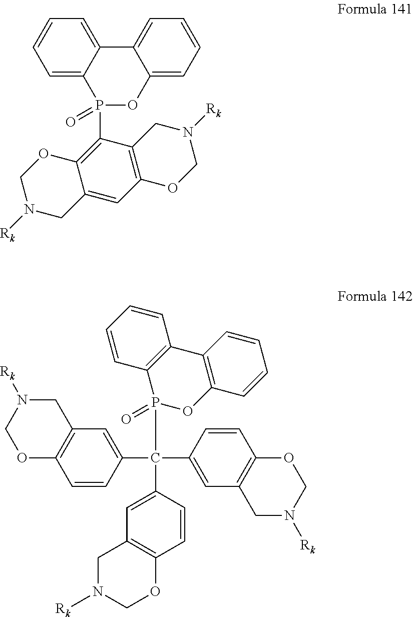

wherein in Formula 141 and 142, Rₖ is selected from groups represented by Formulae 143 below:

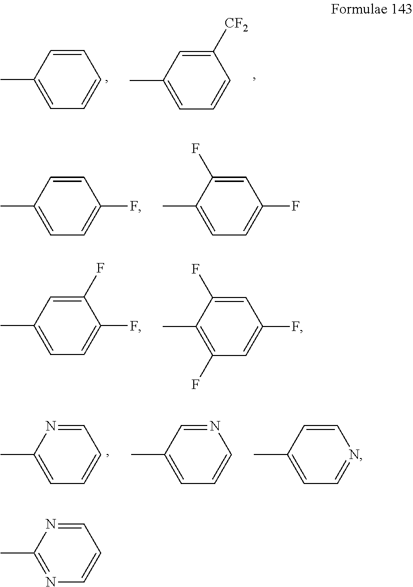

Examples of the compound of Formula 5 are compounds represented by Formulae 144 to 149 below:

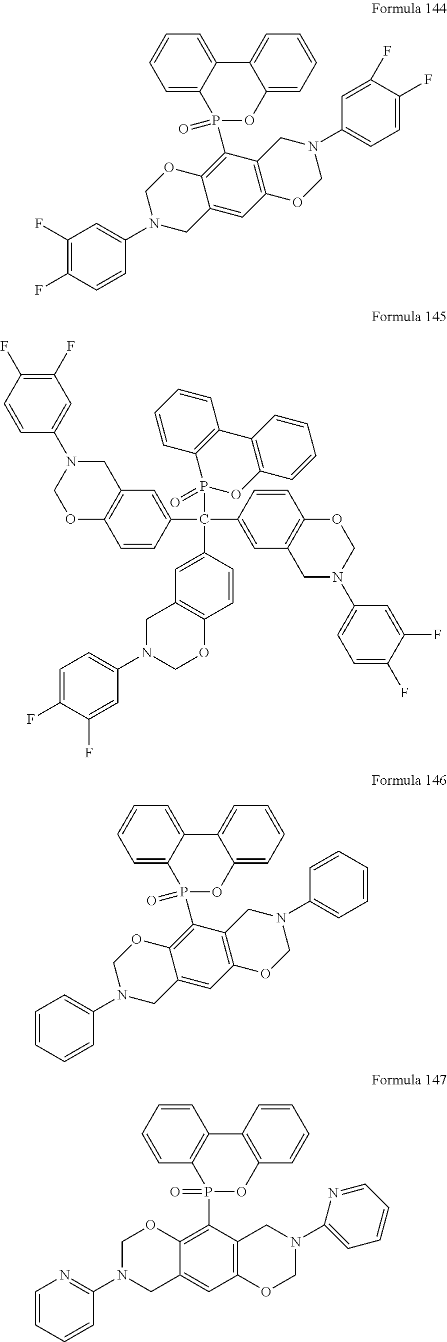 [SMILES: O=P1(c2c3c(cc4c2OCN(c2ccc(F)c(F)c2)C4)OCN(c2ccc(F)c(F)c2)C3)Oc2ccccc2-c2ccccc21 ; O=P1(C(c2ccc3c(c2)CN(c2ccc(F)c(F)c2)CO3)(c2ccc3c(c2)CN(c2ccc(F)c(F)c2)CO3)c2ccc3c(c2)CN(c2ccc(F)c(F)c2)CO3)Oc2ccccc2-c2ccccc21 ; O=P1(c2c3c(cc4c2OCN(c2ccccc2)C4)OCN(c2ccccc2)C3)Oc2ccccc2-c2ccccc21 ; O=P1(c2c3c(cc4c2OCN(c2ccccn2)C4)OCN(c2ccccn2)C3)Oc2ccccc2-c2ccccc21]

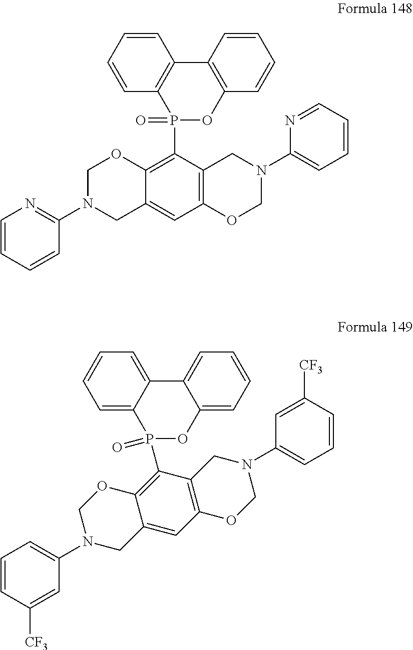 [SMILES: O=P1(c2c3c(cc4c2OCN(c2ccccn2)C4)OCN(c2ccccn2)C3)Oc2ccccc2-c2ccccc21 ; O=P1(c2c3c(cc4c2OCN(c2cccc(C(F)(F)F)c2)C4)OCN(c2cccc(C(F)(F)F)c2)C3)Oc2ccccc2-c2ccccc21]

Examples of the compound of Formula 6 are compounds represented by Formulae 150, 151, and 152 below:

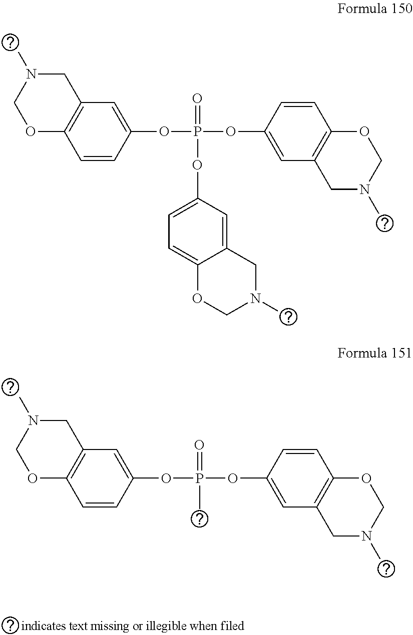 [SMILES: CN1COc2ccc(OP(=O)(Oc3ccc4c(c3)CN(C)CO4)Oc3ccc4c(c3)CN(C)CO4)cc2C1 ; CN1COc2ccc(OP(C)(=O)Oc3ccc4c(c3)CN(C)CO4)cc2C1]

wherein in Formulae 150 and 151, R₁₇′ is a C₁-C₁₀ alkyl group, a C₁-C₁₀ alkoxy group, a C₆-C₁₀ aryl group or a O₆-010 aryloxy group; and
R₁₉′ is selected from groups represented by Formulae 151A below:

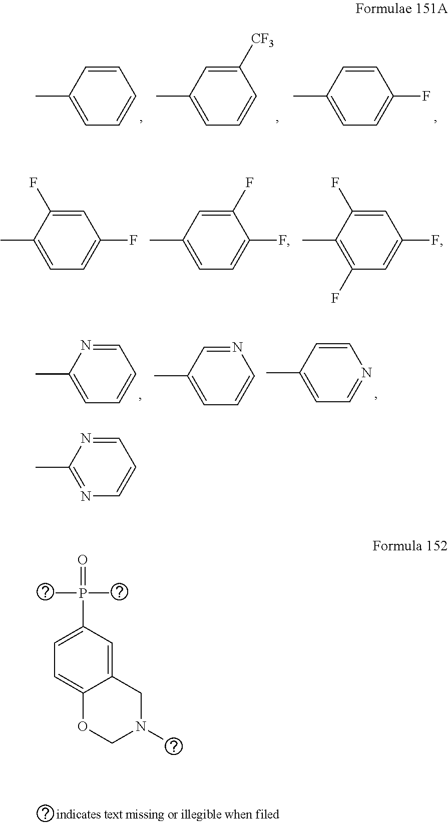

wherein in Formula 152, R₁₇″ is a C₆-C₁₀ aryl group; and
R₁₉″ is selected from groups represented by Formulae 152A below:

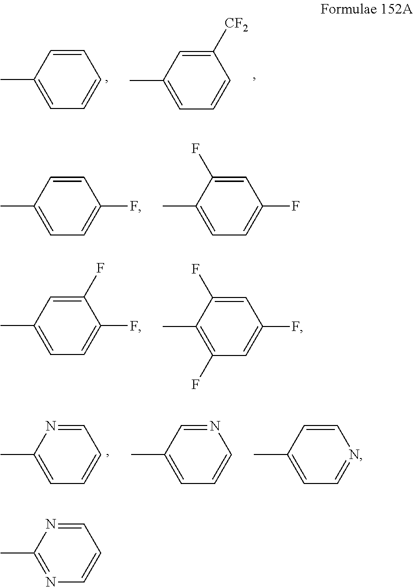

Examples of the compound of Formula 6 are compounds represented by Formulae 153 and 154.

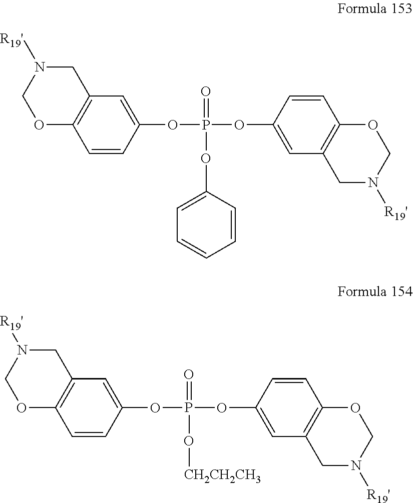

wherein in Formulae 153 and 154, R₁₉′ is selected from groups represented by Formulae 154A below:

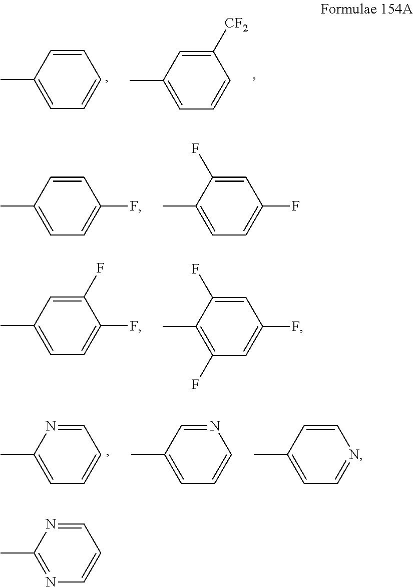

Examples of the compound of Formula 6 are compounds represented by Formulae 155 to 161:

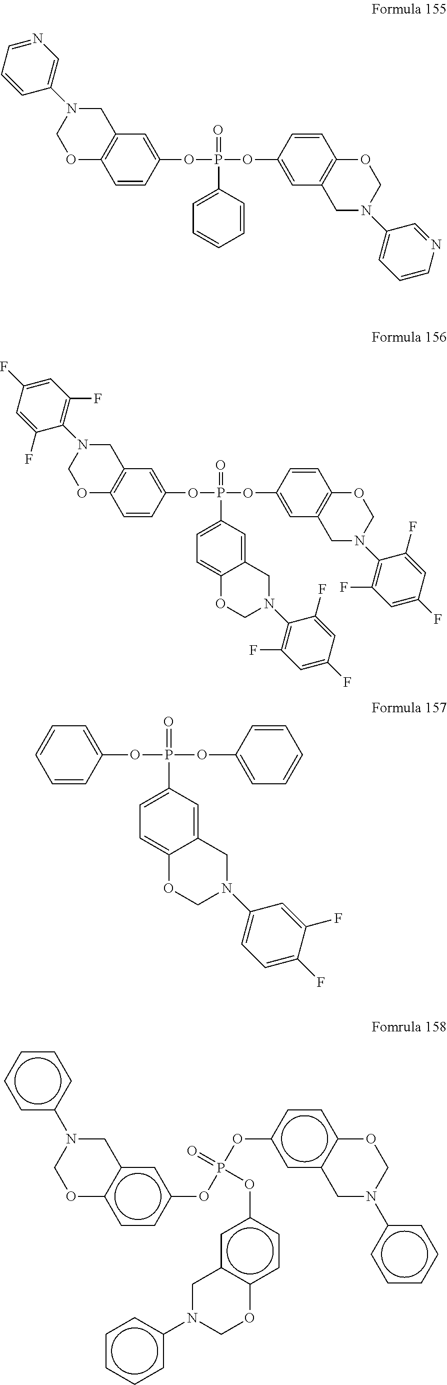

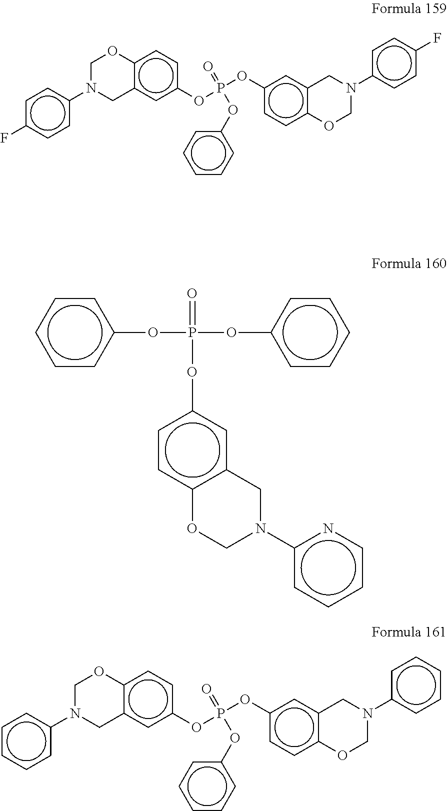

Examples of the compound of Formula 7 are compounds represented by Formulae 162 and 164.

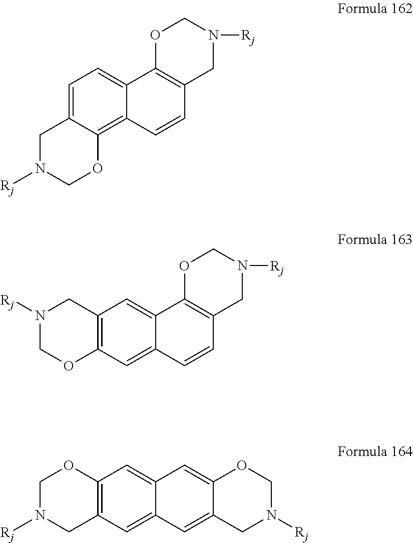

wherein in Formulae 162 to 164, Rⱼ is selected from groups represented by Formulae 164A below:

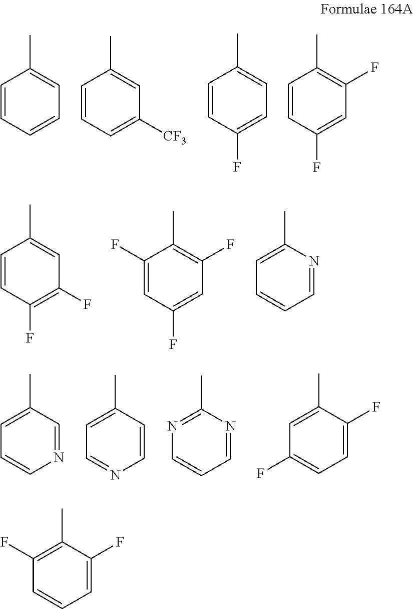

Examples of the compound of Formula 7 are compounds represented by Formulae 165 to 172.

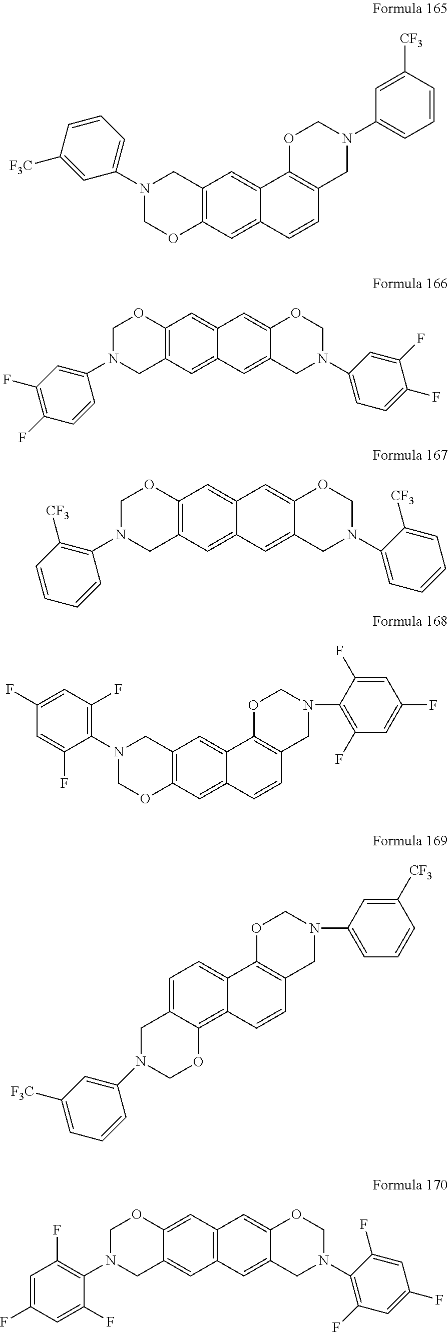 [SMILES: FC(F)(F)c1cccc(N2COc3cc4ccc5c(c4cc3C2)OCN(c2cccc(C(F)(F)F)c2)C5)c1 ; Fc1ccc(N2COc3cc4cc5c(cc4cc3C2)CN(c2ccc(F)c(F)c2)CO5)cc1F ; FC(F)(F)c1ccccc1N1COc2cc3cc4c(cc3cc2C1)CN(c1ccccc1C(F)(F)F)CO4 ; Fc1cc(F)c(N2COc3cc4ccc5c(c4cc3C2)OCN(c2c(F)cc(F)cc2F)C5)c(F)c1 ; FC(F)(F)c1cccc(N2COc3c(ccc4c5c(ccc34)CN(c3cccc(C(F)(F)F)c3)CO5)C2)c1 ; Fc1cc(F)c(N2COc3cc4cc5c(cc4cc3C2)CN(c2c(F)cc(F)cc2F)CO5)c(F)c1]

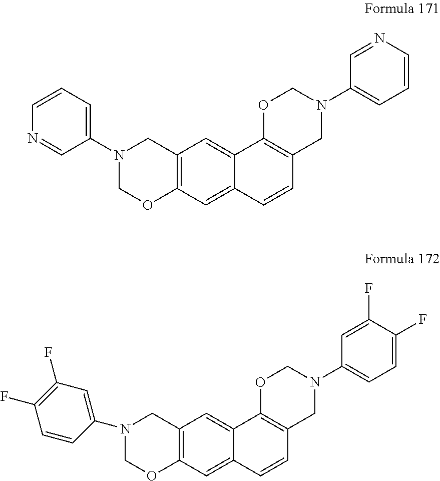 [SMILES: c1cncc(N2COc3cc4ccc5c(c4cc3C2)OCN(c2cccnc2)C5)c1 ; Fc1ccc(N2COc3cc4ccc5c(c4cc3C2)OCN(c2ccc(F)c(F)c2)C5)cc1F]

According to another embodiment of the present disclosure, the electrolyte membrane may include, for example, Sn_{0.9}In_{0.1}P₂O₇, an azole-based polymer, and a compound (“tPPOa”) represented by the following formula.

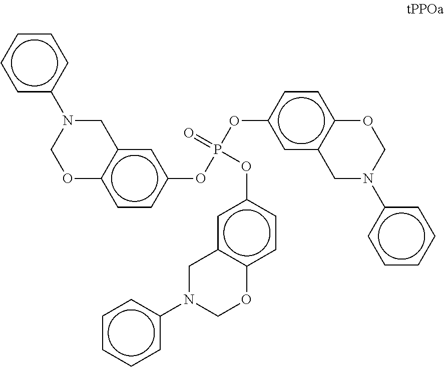

The azole-based polymer may be 2,5-polybenzimidazole, poly(2,2′-(m-phenylene)-5,5′-bibenzimidazole) (“m-PBI”), or poly(2,2′-(p-phenylene)-5,5′-bibenzimidazole) (“p-PBI”).

The electrolyte membrane may further include a phosphoric acid-based material.

Examples of the phosphoric acid-based material are phosphoric acid, polyphosphoric acid, phosphonic acid (H₃PO₃), ortho-phosphoric acid (H₃PO₄), pyro-phosphoric acid (H₄P₂O₇), triphosphoric acid (H₅P₃O₁₀), meta-phosphoric acid, and a derivative thereof. In an embodiment, the phosphoric acid-based material may be phosphoric acid.

A concentration of the phosphoric acid-based material may be from about 80 percent by weight (“wt %”) to about 100 wt %, and in some embodiments, may be about 85 wt %.

A doping level of the phosphoric acid-based material in the electrolyte membrane may be from about 200% to about 350%, and in another embodiment, may be about 310%. The doping level of the phosphoric acid-based material is defined by Equation 1 below.

Doping level of phosphoric acid-based material (%)=(W−Wₚ)/Wₚ×100 Equation 1

In Equation 1, W and Wₚ indicate the weights of the electrolyte membrane after and before doping with the phosphoric acid-based material, respectively.

Hereinafter, a method of preparing the electrolyte membrane described above, which includes a composite as a polymerization product of the compound of Formula 1, and an azole-based polymer, and at least one of compounds of Formulae 2-7, according to an embodiment of the present disclosure, will now be described.

The compound of Formula 1, the azole-based polymer, and the at least one of compounds of Formulae 2 to 7 are mixed together to obtain a composition.

Afterward, the composition is subjected to coating and thermal treatment, thereby obtaining the electrolyte membrane including the composite.

The coating of the composition is not limited to a specific method, and may be performed by dipping, spray coating, screen printing, coating using a doctor blade, coating using Gravure coating, dip coating, roll coating, comma coating, silk screen, or a combination of these methods.

In an embodiment, the coating of the composition may be performed by applying the composition to a substrate, leaving the substrate at a predetermined temperature to allow the composition to uniformly spread over the substrate, and shaping the composition in membrane form having a predetermined thickness by using a coater, such as a doctor blade.

The mixing of the compound of Formula 1, the azole-based polymer, and the at least one of compounds of Formulae 2-7, is not limited to, for example, the order of addition of each component, and solvent use.

In an embodiment, the mixing may include grinding and mixing the azole-based polymer and the at least one of compounds of Formulae 2-7 to obtain mixed powder, which may then be mixed with the compound of Formula 1 and a first solvent at the same time. Through this mixing process individual components in the composition may be uniformly dispersed and mixed so that workability in forming the electrolyte membrane using the composition may be improved.

In the mixing of the azole-based polymer and the at least one of compounds of Formulae 2-7, a second solvent may be added.

In mixing the mixed powder, the compound of Formula 1, and the first solvent, a ball mill, for example, a planetary ball mill, may be used to grind and mix the components at the same time.

The thermal treatment may be performed at a temperature of room temperature (from about 20° C. to about 25° C.) to about 250° C., and in some embodiments, from about 20° C. to about 25° C. When the thermal treatment is performed within these temperature ranges, an electrolyte membrane with improved conductivity may be obtained without a reduction in mechanical strength.

Non-limiting examples of the first and second solvents are tetrahydrofuran (“THF”), N-methylpyrrolidone (“NMP”), and N,N-dimethylacetamide (“DMAC”).

The amounts of the first and second solvents may be adjusted based on the amount of the compound of Formula 1 above.

The amount of the first solvent may be from about 100 parts to about 1,000 parts by weight based on 100 parts by weight of the compound of Formula 1. Also, the amount of the second solvent may be from about 100 parts to about 1,000 parts by weight based on 100 parts by weight of the azole-based polymer and the at least one of compounds of Formulae 2-7 above.

When the amounts of the first and second solvents are within these ranges, the composition including the compound of Formula 1, the azole-based polymer, and the at least one of compounds of Formulae 2-7 may have an appropriate solid content of about 20 wt % to about 35 wt % with an appropriate viscosity, which may improve workability in forming the electrolyte membrane using the composition.

In an embodiment, the composition may be coated on a substrate and thermally treated to form a film, which is then separated from the substrate, thereby obtaining an electrolyte membrane.

The thermal treatment may be performed at a temperature of about 80° C. to about 250° C. When the thermal treatment is performed within this temperature range, an electrolyte membrane with high conductivity and uniform thickness may be obtained without a reduction in mechanical strength.

The substrate is not limited. For example, the substrate may be any of a variety of supports, such as a glass substrate, a release film, or an anode electrode.

Non-limiting examples of the release film are a polytetrafluoroethylene film, a polyvinylidenefluoride film, a polyethyleneterepthalate film, and a mylar film.

The electrolyte membrane obtained through the above-described processes may be supplied with a phosphoric acid-based material. When the phosphoric acid-based material is supplied to the electrolyte membrane, a reaction temperature may be from about 3° C. to about 120° C., and in some embodiments, about 60° C.

The phosphoric acid-based material may be supplied to the electrolyte membrane in any of a variety of manners. For example, the electrolyte membrane may be immersed in the phosphoric acid-based material.

The electrolyte membrane prepared through the above-described processes may have a thickness of about 1 micromolar (“μm”) to about 100 μm, and in some embodiments, about 30 μm to about 90 μm. The electrolyte membrane may be formed as a thin film having a thickness as defined above.

The electrolyte membrane may be used as a non-humidified proton conductor, and may be used in a fuel cell operating at high-temperature, non-humidified conditions. The term “high temperature” refers to a temperature of about 15° C. to about 40° C.; however, the high temperature is not particularly limited.

According to another embodiment of the present disclosure, there is provided a fuel cell that includes the above-described electrolyte membrane between a cathode and an anode. The fuel cell may have high efficiency characteristics because of its high proton conductivity and lifetime characteristics at high temperatures in non-humidified conditions.

The fuel cell may be used for any purpose. For example, the fuel cell may be used to implement a solid oxide fuel cell (“SOFC”), a proton exchange membrane fuel cell (“PEMFCs”), and the like.

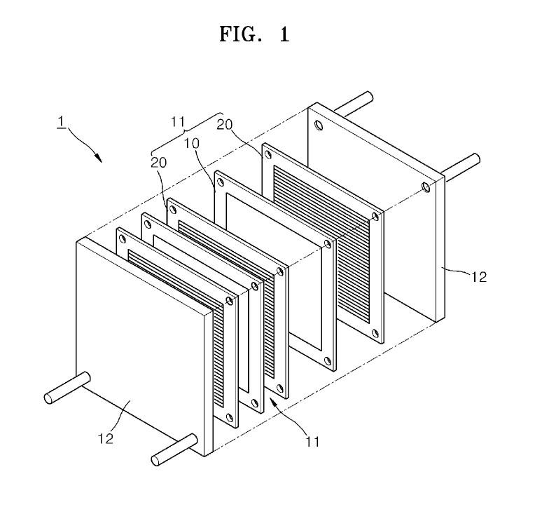

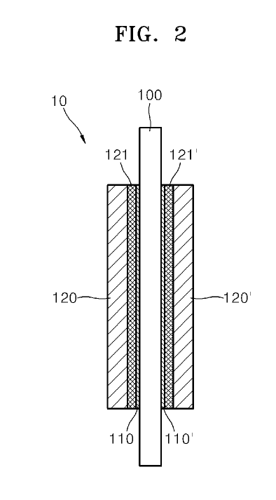

FIG. 1 is a perspective exploded view of a fuel cell 1 according to an embodiment of the present disclosure. FIG. 2 is a cross-sectional diagram of a membrane-electrode assembly (“MEA”) that forms the fuel cell 1 of FIG. 1.

Referring to FIG. 1, the fuel cell 1 includes two unit cells 11 that are supported by a pair of holders 12. Each unit cell 11 includes an MEA 10, and bipolar plates 20 disposed on lateral sides of the MEA 10. Each bipolar plate 20 includes a conductive metal, carbon or the like, and operates as a current collector, while providing oxygen and fuel to the catalyst layers of the corresponding MEA 10.

Although only two unit cells 11 are shown in FIG. 1, the number of unit cells may not be limited to two and a fuel cell may have several tens or hundreds of unit cells, depending on the required properties of the fuel cell.

As shown in FIG. 2, the MEA 10 includes an electrolyte membrane 100, catalyst layers 110 and 110′ disposed on lateral sides of the electrolyte membrane 100, and first gas diffusion layers 121 and 121′ respectively stacked on the catalyst layers 110 and 110′, and second gas diffusion layers 120 and 120′ respectively stacked on the first gas diffusion layers 121 and 121′.

The electrolyte membrane 100 may be the electrolyte membrane described above, which includes a composite as described above.

The catalyst layers 110 and 110′ respectively operate as a fuel electrode and an oxygen electrode, each including a catalyst and a binder therein. The catalyst layers 110 and 110′ may further include a material that may increase the electrochemical surface area of the catalyst.

The first gas diffusion layers 121 and 121′ and the second gas diffusion layers 120 and 120′ may each be formed of a material such as, for example, carbon sheet or carbon paper. The first gas diffusion layers 121 and 121′ and the second gas diffusion layers 120 diffuse oxygen and fuel supplied through the bipolar plates 20 (shown in FIG. 1) into the entire surfaces of the catalyst layers 110 and 110′.

The fuel cell 1 including the MEA 10 operates at a temperature of, for example, about 150° C. to about 300° C. Fuel such as hydrogen is supplied through one of the bipolar plates 20 into a first catalyst layer, and an oxidant such as oxygen is supplied through the other bipolar plate 20 into a second catalyst layer. Then, hydrogen is oxidized into protons in the first catalyst layer, and the protons conduct to the second catalyst layer through the electrolyte membrane 100. Then, the protons electrochemically react with oxygen in the second catalyst layer to produce water and electrical energy. Hydrogen produced from reformation of hydrocarbons or alcohols may be supplied as the fuel. Oxygen as the oxidant may be supplied in the form of air.

Hereinafter, a method of manufacturing a fuel cell using the composite membrane described above, according to an embodiment of the present disclosure will be described.

Electrodes for a fuel cell that each includes a catalyst layer containing a catalyst and, optionally, a binder.

The catalyst may be platinum (Pt), an alloy or a mixture of platinum (Pt) and at least one metal selected from the group including gold (Au), palladium (Pd), rhodium (Ru), iridium (Ir), ruthenium (Ru), tin (Sn), molybdenum (Mo), cobalt (Co), and chromium (Cr). The Pt, the alloy, or the mixture may be supported on a carbonaceous support. For example, the catalyst may be at least one metal selected from the group including Pt, a PtCo alloy, and a PtRu alloy. These metals may be supported on a carbonaceous support.

The binder may be at least one of poly(vinylidenefluoride), polytetrafluoroethylene, a tetrafluoroethylene-hexafluoroethylene copolymer, and perfluoroethylene. The amount of the binder may be from about 0.001 parts to about 0.5 parts by weight based on 1 part by weight of the catalyst, in some embodiments, from about 0.01 parts to about 0.4 parts by weight based on 1 part by weight of the catalyst, and in some other embodiments, from about 0.1 parts to about 0.3 parts by weight based on 1 part by weight of the catalyst. When the amount of the binder is within the foregoing ranges, the electrode catalyst layer may have strong binding ability to the support.

Any of the electrolyte membranes according to the above-described embodiments of the present disclosure, may be disposed between the two electrodes to manufacture the fuel cell.

In some embodiments, the composition including the compound of Formula 1, the azole-based polymer, the at least one of compounds of Formulae 2-7, and a composite obtained therefrom may be used in forming an electrode of a fuel cell.

According to an embodiment of the present disclosure, a method of forming an electrode for a fuel cell may involve dispersing the catalyst in a third solvent to obtain a dispersion.

The third solvent may be N-methylpyrrolidone (“NMP”), N,N′-dimethylacetamide (“DMAC”), or the like. An amount of the third solvent may be from about 100 parts to about 1,000 parts by weight based on 100 parts by weight of the catalyst.

The compound of Formula 1, the azole-based polymer, and the at least one of compounds of Formulae 2-7 may be added to the dispersion and mixed together while stirring, thereby forming a composition for forming an electrode catalyst layer. A binder may be further added to the composition.

The composition for an electrode catalyst layer may be coated on a surface of a carbon support, thereby completing formation of the electrode. Herein, the carbon support may be fixed to a glass substrate to facilitate the coating. The coating method is not particularly limited, but examples of the coating method may be coating using a doctor blade, bar coating, and screen printing.

The coating of the composition for forming the electrode catalyst layer may be followed by thermal treatment, which may be performed at a temperature of from about 2° C. to about 15° C., and in some embodiments about 10° C. to 150° C.

The electrode for fuel cells as a final product may include the composition containing the compound of Formula 1, the azole-based polymer, and the at least one compound selected from Formulae 2-7, or may include the composite derived as a result of polymerization of the compound of Formula 1, the azole-based polymer, and the at least one compound selected from Formulae 2-7 during the above-described thermal treatment and/or operation of a fuel cell employing the electrode.

Substituents in the formulae above may be defined as follows.

As used herein, the term “alkyl” indicates a completely saturated, branched or unbranched (or a straight or linear) hydrocarbon.

Non-limiting examples of the “alkyl” group are methyl, ethyl, n-propyl, iso-propyl, n-butyl, iso-butyl, sec-butyl, t-butyl, iso-pentyl, neo-pentyl, iso-amyl, n-hexyl, 3-methylhexyl, 2,2-dimethylpentyl, 2,3-dimethylpentyl, and n-heptyl.

At least one hydrogen atom of the alkyl group may be substituted with a halogen atom, a C₁-C₂₀ alkyl group substituted with a halogen atom (for example, CCF₃, CHCF₂, CH₂F, CCl₃, and the like), a C₁-C₂₀ alkoxy group, a C₂-C₂₀ alkoxyalkyl group, a hydroxyl group, a nitro group, a cyano group, an amino group, an amidino group, a hydrazine group, a hydrazone group, a carboxyl group or a salt thereof, a sulfonyl group, a sulfamoyl group, a sulfonic acid group or a salt thereof, a phosphoric acid or a salt thereof, a C₁-C₂₀ alkyl group, a C₂-C₂₀ alkenyl group, a C₂-C₂₀ alkynyl group, a C₁-C₂₀ heteroalkyl group, a C₆-C₂₀ aryl group, a C₆-C₂₀ arylalkyl group, a C₆-C₂₀ heteroaryl group, a C₇-C₂₀ heteroarylalkyl group, a C₆-C₂₀ heteroaryloxyl group, a C₆-C₂₀ heteroaryloxyalkyl group, or a C₆-C₂₀ heteroarylalkyl group.

As used herein, the term “cycloalkyl” indicates a monovalent group having one or more saturated rings in which all ring members are carbon (e.g., cyclopentyl and cyclohexyl).

The term “halogen atom” indicates fluorine, bromine, chloride, iodine, and the like.

The term “C₁-C₂₀ alkyl group substituted with a halogen atom” indicates a C₁-C₂₀ alkyl group substituted with at least one halo group. Non-limiting examples of the C₁-C₂₀ alkyl group substituted with a halogen atom are polyhaloalkyls including monohaloalkyl, or perhaloalkyl such as dihaloalkyl.

Monohaloalkyls indicate alkyl groups including one iodine, bromine, chloride or fluoride. Dihaloalkyls and polyhaloalkyls indicate alkyl groups including at least two identical or different halo atoms.

As used herein, the term “halogenated” indicates a structural moiety substituted with one or more halogen atoms.

As used herein, the term “alkoxy” represents “alkyl-O—”, wherein the term “alkyl” has the same meaning as described above. Non-limiting examples of the alkoxy group are methoxy, ethoxy, propoxy, 2-propoxy, n-butoxy, sec-butoxy, t-butoxy, pentyloxy, hexyloxy, cyclopropoxy, and cyclohexyloxy. At least one hydrogen atom of the alkoxy group may be substituted with substituents that are the same as those described above in conjunction with the alkyl group.

As used herein, the term “alkoxyalkyl” indicates an alkyl group with a substituent that is the same as that described above in conjunction with the alkoxy group. At least one hydrogen atom of the alkoxyalkyl group may be substituted with substituents that are the same as those described above in conjunction with the alkyl group. As defined above, the term “alkoxyalkyl” refers to substituted alkoxyalkyl moieties.

As used herein, the term “alkenyl” indicates a branched or unbranched hydrocarbon with at least one carbon-carbon double bond. Non-limiting examples of the alkenyl group are vinyl, aryl, butenyl, iso-propenyl, and iso-butenyl. At least one hydrogen atom in the alkenyl group may be substituted with a substituent that is the same as that described above in conjunction with the alkyl group.

As used herein, the term “alkynyl” indicated a branched or unbranched hydrocarbon with at least one carbon-carbon triple bond. Non-limiting examples of the “alkynyl” group are ethynyl, butynyl, iso-butynyl, and iso-propynyl.

At least one hydrogen atom of the alkynyl groups may be substituted by the same substituents as those described above in conjunction with the alkyl group.

As used herein, the term “aryl” group, which is used alone or in combination, indicates an aromatic hydrocarbon containing at least one ring.

The term “aryl” is construed as including a group with an aromatic ring fused to at least one cycloalkyl ring.

Non-limiting examples of the “aryl” group are phenyl, naphthyl, and tetrahydronaphthyl.

At least one hydrogen atom in the aryl group may be substituted with the same substituent as described above in conjunction with the alkyl group.

The term “arylalkyl” indicates an alkyl group substituted with an aryl group. Examples of the “arylalkyl” group include benzyl and phenyl (—CH₂CH₂—).

As used herein, the term “aryloxy” indicates “—O-aryl”. An example of the aryloxy group is phenoxy. At least one hydrogen atom of the “aryloxy” group may be substituted with substituents that are the same as those described above in conjunction with the alkyl group.

As used herein, the term “heteroaryl group” indicates a monocyclic or bicyclic organic compound including at least one heteroatom selected from nitrogen (N), oxygen (O), phosphorous (P), and sulfur (S), wherein the rest of the cyclic atoms are all carbon. The heteroaryl group may include, for example, one to five heteroatoms, and in some embodiments, may include a five- to ten-membered ring.

In the heteroaryl group, S or N may be present in various oxidized forms.

Non-limiting examples of the monocyclic heteroaryl group are thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiaxolyl, 1,2,3-thiadiazolyl, 1,2,4-thiadiazolyl, 1,2,5-thiadiazolyl, 1,3,4-thiazolyl, isothiazol-3-yl, isothiazol-4-yl, isothiazol-5-yl, oxazol-2-yl, oxazol-4-yl, oxazol-5-yl, isoxazol-3-yl, isoxazol-4-yl, isoxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, and 5-pyrimidin-2-yl.

The term “heteroaryl” indicates a heteroaromatic ring fused to at least one of an aryl group, a cycloaliphatic group, and a heterocyclic group.

Non-limiting examples of the bicyclic heteroaryl group are indolyl, isoindolyl, indazolyl, indolizinyl, purinyl, quinolizinyl, quinolinyl, isoquinolinyl, cinnolinyl, phthalazinyl, naphthyridinyl, quinazolinyl, quinaxalinyl, phenanthridinyl, phenathrolinyl, phenazinyl, phenothiazinyl, phenoxazinyl, benzisoqinolinyl, thieno[2,3-b]furanyl, furo[3,2-b]-pyranyl, 5H-pyrido[2,3-d]-o-oxazinyl, 1H-pyrazolo[4,3-d]-oxazolyl, 4H-imidazo[4,5-d]thiazolyl, pyrazino[2,3-d]pyridazinyl, imidazo[2,1-b]thiazolyl, imidazo[1,2-b][1,2,4]triazinyl, 7-benzo[b]thienyl, benzoxazolyl, benzimidazolyl, benzothiazolyl, benzoxapinyl, benzoxazinyl, 1H-pyrrolo[1,2-b][2]benzazapinyl, benzofuryl, benzothiophenyl, benzotriazolyl, pyrrolo[2,3-b]pyridinyl, pyrrolo[3,2-c]pyridinyl, pyrrolo[3,2-b]pyridinyl, imidazo[4,5-b]pyridinyl, imidazo[4,5-c]pyridinyl, pyrazolo[4,3-d]pyridinyl, pyrazolo[4,3-c]pyridinyl, pyrazolo[3,4-c]pyridinyl, pyrazolo[3,4-d]pyridinyl, pyrazolo[3,4-b]pyridinyl, imidazo[1,2-a]pyridinyl, pyrazolo[1,5-a]pyridinyl, pyrrolo[1,2-b]pyridazinyl, imidazo[1,2-c]pyrimidinyl, pyrido[3,2-d]pyrimidinyl, pyrido[4,3-d]pyrimidinyl, pyrido[3,4-d]pyrimidinyl, pyrido[2,3-d]pyrimidinyl, pyrido[2,3-b]pyrazinyl, pyrido[3,4-b]pyrazinyl, pyrimido[5,4-d]pyrimidinyl, pyrazino[2,3-b]pyrazinyl, and pyrimido[4,5-d]pyrimidinyl.

At least one hydrogen atom of the heteroaryl group may be substituted with the same substituent as described above in conjunction with the alkyl group.

The term “heteroarylalkyl” group indicates an alkyl group substituted with a heteroaryl group.

The term “heteroaryloxy” group indicates a “—O-heteroaryl moiety”. At least one hydrogen atom of the heteroaryloxy group may be substituted with substituents that are the same as those described above in conjunction with the alkyl group.

The term “heteroaryloxyalkyl” group indicates an alkyl group substituted with a heteroaryloxy group. At least one hydrogen atom of the heteroaryloxyalkyl group may be substituted with substituents that are the same as those described above in conjunction with the alkyl group.

As used herein, the term “carbocyclic” group indicates a saturated or partially unsaturated non-aromatic monocyclic, bicyclic or tricyclic hydrocarbon group.

Non-limiting examples of the monocyclic hydrocarbon group are cyclopentyl, cyclopentenyl, cyclohexyl, and cyclohexenyl.

Non-limiting examples of the bicyclic hydrocarbon group are bornyl, decahydronaphthyl, bicyclo[2.1.1]hexyl, bicyclo[2.2.1]heptyl, bicyclo[2.2.1]heptenyl, and bicyclo[2.2.2]octyl.

An example of the tricyclic hydrocarbon group is adamantyl.

At least one hydrogen atom of the “carbocyclic group” may be substituted with substituents that are the same as those described above in conjunction with the alkyl group.

As used herein, the term “heterocyclic group” in the formulae above refers to a five to ten-membered ring including a heteroatom such as N, S, P, or O. An example of the heterocyclic group is pyridyl. At least one hydrogen atom in the heterocyclic group may be substituted with the same substituent as described above in conjunction with the alkyl group.

The term “heterocyclic oxy” indicates “—O-hetero ring”. At least one hydrogen atom of the heterocyclic oxy group may be substituted with substituents that are the same as those described above in conjunction with the alkyl group.

The term “sulfonyl” indicates R″—SO₂—, wherein R″ is a hydrogen atom, alkyl, aryl, heteroaryl, aryl-alkyl, heteroaryl-alkyl, alkoxy, aryloxy, cycloalkyl, or a heterocyclic group.

The term “sulfamoyl” group refers to H₂NS(O₂)—, alkyl-NHS(O₂)—, (alkyl)₂NS(O₂)— aryl-NHS(O₂)—, alkyl-(aryl)-NS(O₂)—, (aryl)₂NS(O)₂, heteroaryl-NHS(O₂)—, (aryl-alkyl)-NHS(O₂)—, or (heteroaryl-alkyl)-NHS(O₂)—.

At least one hydrogen atom of the sulfamoyl group may be substituted with substituents that are the same as those described above in conjunction with the alkyl group.

The term “amino group” indicates a group with a nitrogen atom covalently bonded to at least one carbon or hetero atom. The amino group may refer to, for example, —NH₂ and substituted moieties.

The term “amino group” also refers to an “alkylamino group” with nitrogen bound to at least one additional alkyl group, and “arylamino” and “diarylamino” groups with at least one or two nitrogen atoms bound to a selected aryl group.

The terms “alkylene”, “alkenylene”, “alkynylene”, “arylene”, and “heteroarylene” are respectively defined to be same as the monovalent “alkyl”, “alkenyl”, “alkynyl”, “aryl” and “heteroaryl” described above, except that they are divalent groups.

At least one hydrogen atom of the respective “alkylene”, “alkenylene”, “alkynylene”, “arylene”, and “heteroarylene” groups may be substituted with substituents that are the same as those described above in conjunction with the alkyl group.

The term “aromatic” includes a cyclic hydrocarbon with alternating carbon and single bonds between carbon atoms.

The term “heteroaromatic” includes an aromatic hydrocarbon wherein at least one of the carbon atoms is replaced with a heteroatom.

Hereinafter, one or more embodiments of the present disclosure will be described in detail with reference to the following examples. These examples are not intended to limit the purpose and scope of the one or more embodiments of the present disclosure.

### Example 1

### Preparation of Composite and Electrolyte Membrane

A compound (m-PBI) represented by the following formula and a compound (tPPOa) represented by the following formula were dissolved in 1:1 by weight in a N,N-dimethylacetamide (“DMAc”) solvent and were mixed together to obtain a first mixture. An amount of the DMAc solvent was adjusted so that the first mixture had a solid content of about 32 wt %.

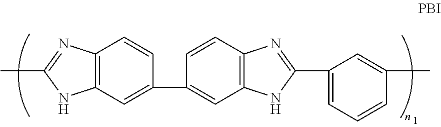

In the formula above, n₁ was 30.

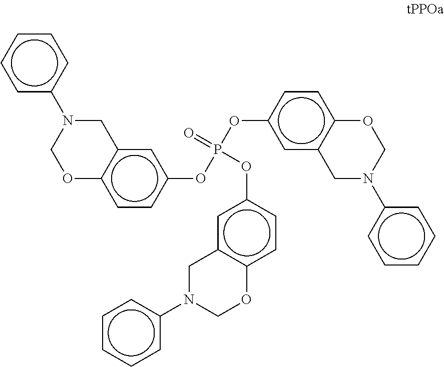

Sn_{0.9}In_{0.1}P₂O₇ (hereinafter, “SIPO”) powder was ground using a mortar, and was then mixed with the first mixture in a glass vessel using a stirrer to obtain a second mixture. The amount of SIPO in the second mixture and the total amount of m-PBI and tPPOa in the first mixture were in about 10:90 by weight. To provide the second mixture with an appropriate viscosity, DMAc was added so that the second mixture had a solid content of about 25 wt %.

The second mixture was ground and mixed by using a planetary ball mill at about 150 rounds per minute (“rpm”) for about 14 hours to obtain a composition.

The composition was cast on an even glass plate by using a doctor blade, and was then thermally treated in a convection oven at gradually increasing temperature from room temperature to about 25° C. to form a film.

The film was separated from the glass plate as an electrolyte membrane A.

The electrolyte membrane A was immersed in a 85 wt % H₃PO₄ solution at about 8° C. overnight to obtain an electrolyte membrane including a phosphoric acid-doped composite.

The electrolyte membrane had a phosphoric acid content of about 322 wt % and a thickness of about 88 μm.

### Example 2

### Preparation of Composite and Electrolyte Membrane

A composite and an electrolyte membrane were prepared in the same manner as in Example 1, except that the mixed ratio of SIPO in the second mixture to m-PBI and tPPOa in the first mixture was about 20:80 by weight, and the amount of DMAc was adjusted so that the second mixture had a solid content of about 22 wt %.

### Example 3

### Preparation of Composite and Electrolyte Membrane

A composite and an electrolyte membrane were prepared in the same manner as in Example 1, except that the mixed ratio of SIPO in the second mixture to m-PBI and tPPOa in the first mixture was about 30:70 by weight, and the amount of DMAc was adjusted so that the second mixture had a solid content of about 20 wt %.

### Reference Example 1

### Manufacture of Electrolyte Membrane

5.0 g of a solution of a compound (m-PBI) (10 wt % in DMAc) represented by the following formula was cast on a glass substrate by using a doctor blade, and was dried at about 9° C. for about 1 hour, and further at about 12° C. for about 4 hours in a vacuum condition. Then, a resulting film was separated from the surface of the glass substrate, thereby resulting in a PBI membrane.

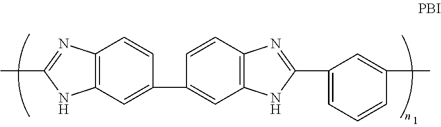

In the formula above, n₁ was 30.

The PBI membrane was immersed in a 80° C., 85 wt % H₃PO₄ solution at about 60° C. overnight to obtain a phosphoric acid-doped PBI electrolyte membrane.

### Evaluation Example 1

### Scanning Electron Microscopic (“SEM”) Analysis of Electrolyte Membrane

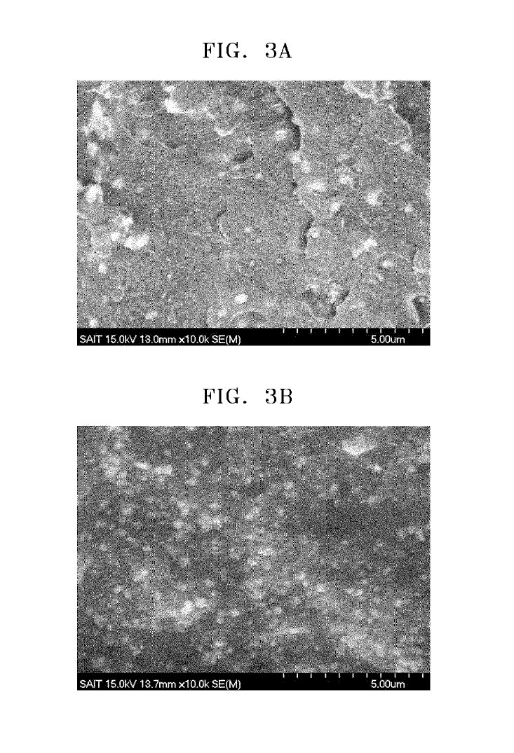

The electrolyte membranes of Examples 1-3 were analyzed using SEM. The results are shown in FIGS. 3A-3C.

Referring to FIGS. 3A to 3C, the electrolyte membranes of Examples 1-3 were found to contain uniformly dispersed SIPO, with a better dispersity of SIPO in the electrolyte membrane of Example 1 as compared with the electrolyte membranes of Examples 2 and 3. The electrolyte membranes of Examples 1-3 with the uniformly dispersed SIPO may have improved durability due to suppressed leakage of the phosphoric acid-based material.

### Evaluation Example 2

### Mechanical Strength Analysis of Electrolyte Membrane

Tensile strengths and elongations of the electrolyte membranes of Examples 1-3 were measured using a universal testing machine (“UTM”) (Lloyd LR-10K). Samples for the measurement were prepared according to ASTM standard D638 (Type V specimens).

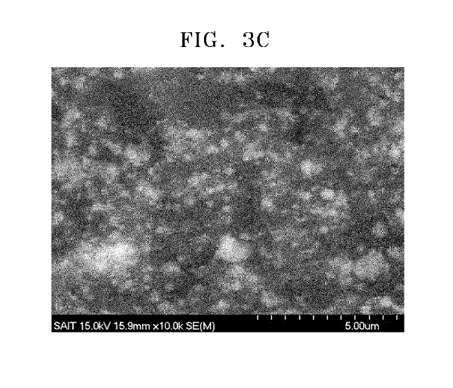

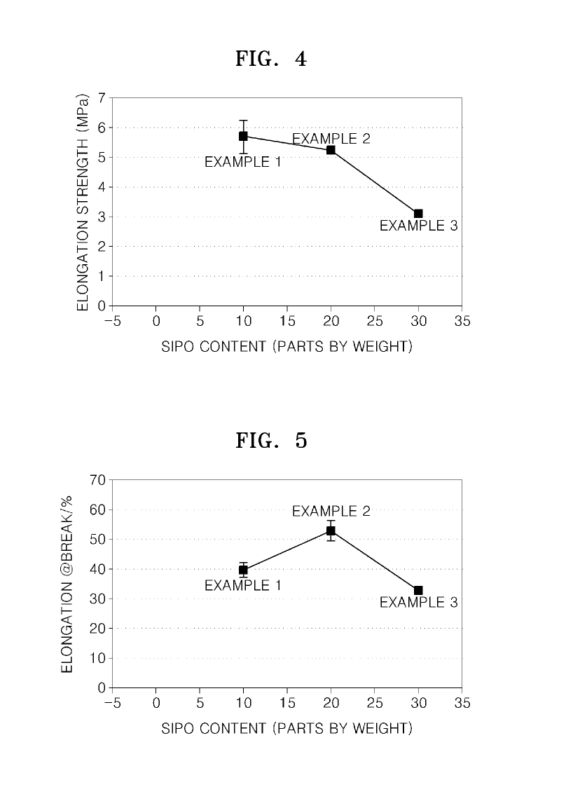

The results of the tensile strength and elongation measurement are shown in Table 1 and FIGS. 4 and 5.

TABLE 1

| | SIPO content | Elongation strength | |
|---|---|---|---|
| Example | (parts by weight) | (MPa) | Elongation (%) |
| Example 1 | 10 | 5.70 | 39.9 |
| Example 2 | 20 | 5.24 | 53.1 |
| Example 3 | 30 | 3.10 | 32.9 |

Referring to Table 1 and FIGS. 4 and 5, the electrolyte membranes of Examples 1-3 were found to have nearly same strong mechanical strengths.

### Evaluation Example 3

### Measurement of Conductivity

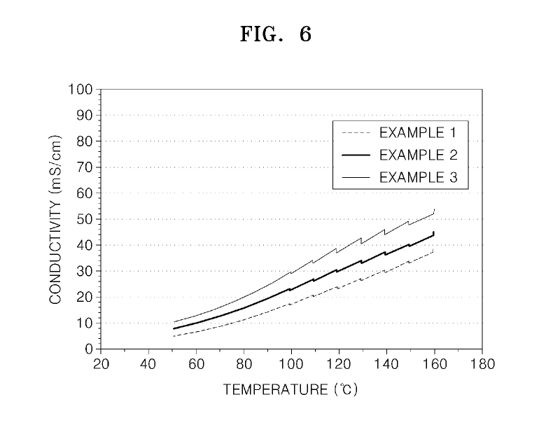

Changes in conductivity with respect to temperature were measured in the electrolyte membranes of Examples 1-3. The results are shown in Table 2 and FIG. 6.

The conductivities were measured according to a 4-point Probe-In Plane method in non-humidified, hydrogen (H₂) (flow rate: about 10 SCCM) conditions using a Bekktec equipment.

TABLE 2

| | SIPO content | |
|---|---|---|
| Example | (parts by weight) | Conductivity (mScm⁻¹) |
| Example 1 | 10 | 34.1 |
| Example 2 | 20 | 49.1 |
| Example 3 | 30 | 40.5 |

Referring to Table 2 and FIG. 6, the electrolyte membranes of Examples 1-3 were found to have high conductivities.

### Evaluation Example 4

### Evaluation of Phosphoric Acid Doping Level

After the first composite membranes A of Examples 1-3 were each immersed in a 85 wt % phosphoric acid solution at about 6° C. overnight, and were drawn out of the solution, followed by removing the phosphoric acid remaining on a surface of the first electrolyte membrane A with ethanol, and weighing the first electrolyte membrane A. The phosphoric acid doping level in the first electrolyte membrane A was estimated according to Equation 1 below. The results are shown in Table 3 below.

H₃PO₄ doping level (%)=(W−Wₚ)/Wₚ×100 Equation 1

In Equation 1, W and Wₚ indicate the weights of the electrolyte membrane after and before doping with the phosphoric acid, respectively.

For comparison, a phosphoric acid doping level in the m-PBI electrolyte membrane of Reference Example 1 is also represented in Table 3.

TABLE 3

| Example | Phosphoric acid doping level (%) |
|---|---|
| Example 1 | 322 |
| Example 2 | 282 |
| Example 3 | 235 |
| Reference Example 1 | 375 |

Referring to FIG. 3, the electrolyte membranes of Examples 1-3 containing SIPO were found to have lower phosphoric acid doping levels as compared with the electrolyte membrane of Reference Example 1.

### Evaluation Example 5

### Evaluation of Cell Performance

Cells were respectively manufactured by disposing the electrolyte membranes of Examples 1-3 and Reference Example 1, each having a thickness of about 88 μm, between a cathode and an anode.

The cathode and anode were manufactured as follows for use in each cell.

First, 0.5 g of platinum, 0.25 g of a benzoxazine-based monomer (4FPh2AP) represented by the following formula, and 5 g of N-methylpyrrolidone were mixed together, thereby preparing a composition for forming a cathode catalyst layer.

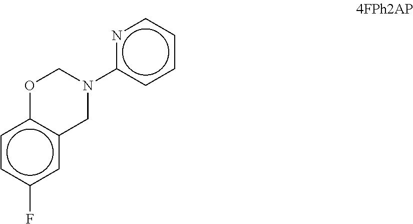

The composition for forming a cathode catalyst layer was coated on an electrode support, and was then dried at about 80° C. for about 1 hour, at about 120° C. for about 20 minutes, and then at about 150° C. for about 10 minutes to form the cathode catalyst layer.

The anode was manufactured by coating a catalyst directly on an electrode support and drying the same at about 80° C. for about 1 hour, at about 12° C. for about 20 minutes, and then at about 15° C. for about 10 minutes.

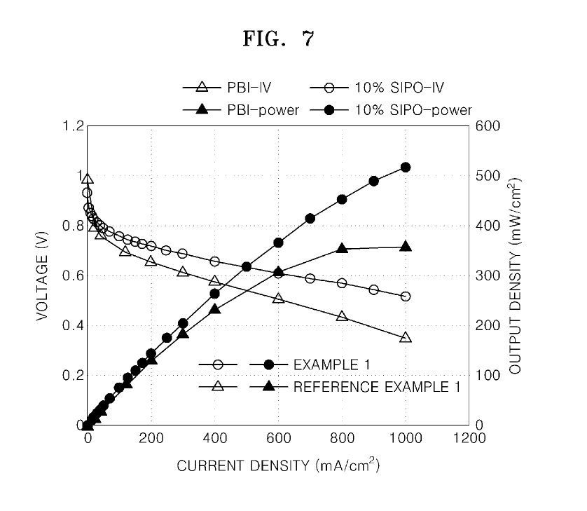

To test performance of each fuel cell, non-humidified H₂ and O₂ were supplied to the anode and cathode at about 50 cubic centimeters (“ccm”) and about 100 ccm, respectively, and the fuel cell was operated at about 10° C. to about 20° C. in non-humidified conditions to measure changes in cell voltage and output density with respect to current density. The results are shown in FIG. 7. In FIG. 7, “PBI-IV” and “PBI-power” indicate cell voltage and output density of the fuel cell including the electrolyte membrane of Reference Example 1, respectively, and “SIPO-IV” and “SIPO-power” indicate cell voltage and output density of the fuel cell including the electrolyte membrane of Example 1, respectively.

Referring to FIG. 7, the fuel cell with the electrolyte membrane of Example 1 was found to have improved output density and cell voltage characteristics even at a lower phosphoric acid doping level, as compared to the fuel cell including the PBI membrane of Reference Example 1.

### Evaluation Example 6

### Evaluation of Cell Durability

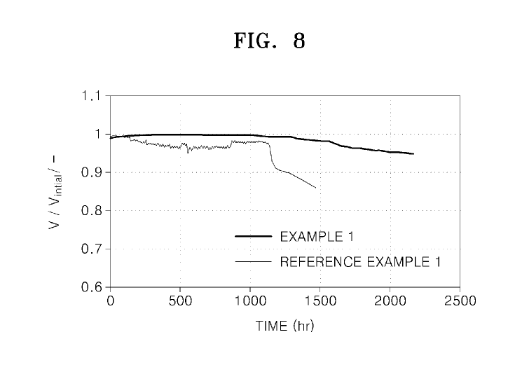

Durabilities of the fuel cells manufactured according to Evaluation Example 5, each fuel cell including either the electrolyte membrane of Example 1 or the PBI membrane of Reference Example 1, were measured. The results are shown in FIG. 8.

Cell durability was measured as a change in open circuit voltage (“OCV”) through repeated cycles of an accelerated lifetime test (“ALT”) mode for about 1 hour per each cycle at a high current density of about 0 to 1 Amperes per square centimeter (Axcm-2).

Referring to FIG. 8, the fuel cell including the electrolyte membrane of Example 1 was found to have stable cell voltage characteristics even after about 1,500 cycles, indicating improved long-term durability.

### Evaluation Example 7

### Solid Nuclear Magnetic Resonance (“NMR”) Analysis

The composite of Example 1 was analyzed by solid nuclear magnetic resonance (“NMR”) analysis using a Bruker NMR 600 MHz (ADVANCE III).

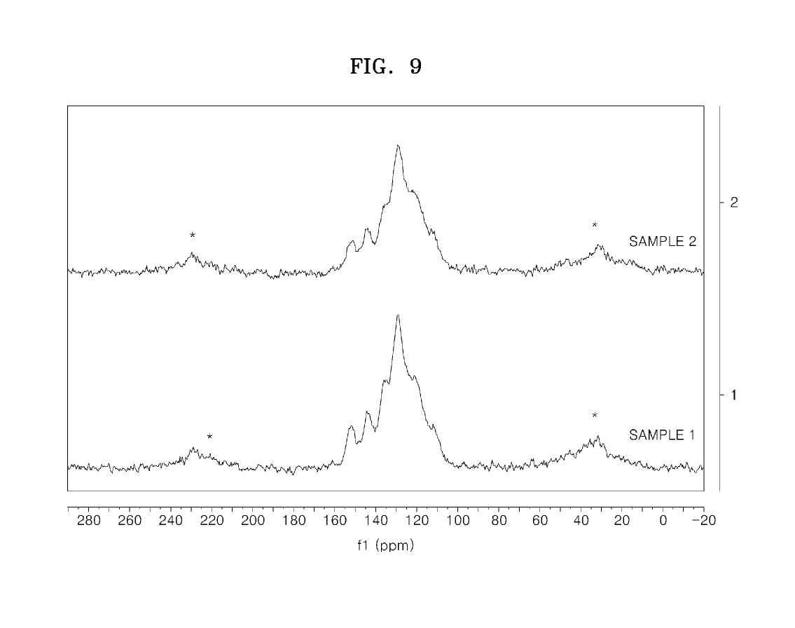

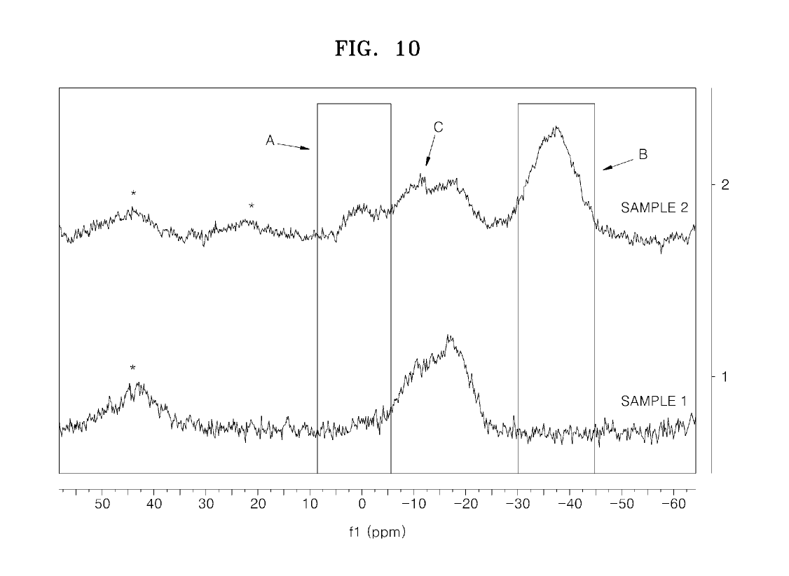

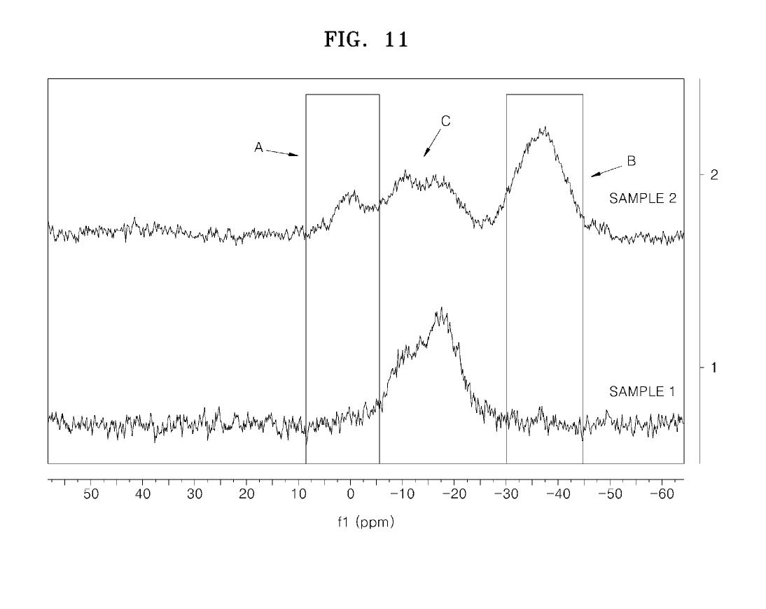

FIG. 9 is ¹³C cross-polarization and magic angle spinning (“CR/MAS”) NMR spectra of samples at a spinning frequency of about 15 kHz. FIGS. 10 and 11 are ³¹P high-power decoupled (“HP-DEC”) NMR spectra of the samples at a spinning frequency of about 15 kHz and about 25 kHz, respectively. In FIGS. 9 to 11, SAMPLE 1 is a mixture of PBI and t-PPO-a as a starting material for synthesizing the composite of Example 1, SAMPLE 2 is the composite of Example 1, and * indicates spinning side bands. Referring to FIGS. 9 to 11, the composite of Example 1 was found not to have a significant change in basic polymer backbone from that of the mixture of PBI and t-PPO-a as the start material (see FIG. 9). A new peak A appeared in the composite of Example 1, indicating generation of sites (P—O bond) able to serve as proton conducting paths (see FIGS. 10 and 11). In FIGS. 10 and 11, the synthesis of the composite of Example 1 is identified from the presence of peaks A and B, which are distinct from a peak C of O═P—(OPh)₃.

As described above, according to the one or more of the above embodiments of the present disclosure, an electrolyte membrane with improvements in conductivity, mechanical strength and durability is prepared. A highly efficient fuel cell with improved cell performance may be manufactured by using the electrolyte membrane.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A composition comprising:
a compound represented by Formula 1;
an azole-based polymer; and
at least one of compounds represented by Formulae 2 to 7:
M¹₁₋ₐM²ₐPₓO_{y} Formula 1
wherein, in Formula 1, M¹ is a tetravalent element;
M² is at least one selected from the group comprising a monovalent element, a divalent element, and a trivalent element;
0≦a<1;
x is a number from 1.5 to 3.5; and
y is a number from 5 to 13, 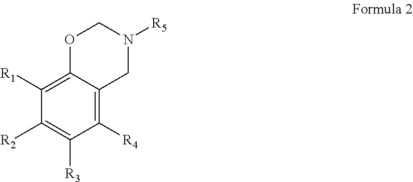
wherein, in Formula 2, R₁, R₂, R₃, and R₄ are each independently a hydrogen atom, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₂-C₂₀ heteroaryl group, a substituted or unsubstituted C₂-C₂₀ heteroaryloxy group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, a halogen atom, a hydroxyl group, or a cyano group; and
R₅ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group, 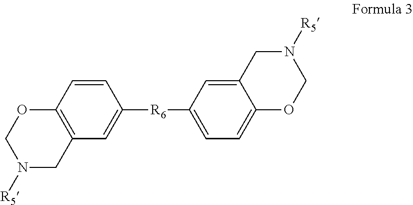
wherein, in Formula 3, R₅′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and
R₆ is a substituted or unsubstituted C₁-C₂₀ alkylene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₂-C₂₀ heteroarylene group, —C(═O)—, or —SO₂—, 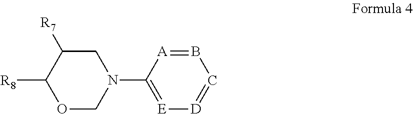
wherein, in Formula 4, A, B, C, D and E are carbon, or one or two of A, B, C, D and E is nitrogen and the others are carbon; and
R₇ and R₈ are linked to form a ring, wherein the ring is a C₆-C₁₀ cycloalkyl group, a C₃-C₁₀ heteroaryl group, a fused C₃-C₁₀ heteroaryl group, a C₃-C₁₀ heterocyclic group, or a fused C₃-C₁₀ heterocyclic group, 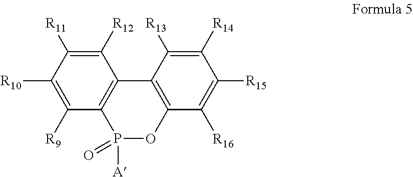
wherein, in Formula 5, A′ is a substituted or unsubstituted C₁-C₂₀ heterocyclic group, a substituted or unsubstituted C₄-C₂₀ cycloalkyl group, or a substituted or unsubstituted C₁-C₂₀ alkyl group; and
R₉ to R₁₆ are each independently a hydrogen atom, a C₁-C₂₀ alkyl group, a C₁-C₂₀ alkoxy group, a C₆-C₂₀ aryl group, a C₆-C₂₀ aryloxy group, a C₁-C₂₀ heteroaryl group, a C₁-C₂₀ heteroaryloxy group, a C₄-C₂₀ cycloalkyl group, a C₁-C₂₀ heterocyclic group, a halogen atom, a cyano group, or a hydroxy group, 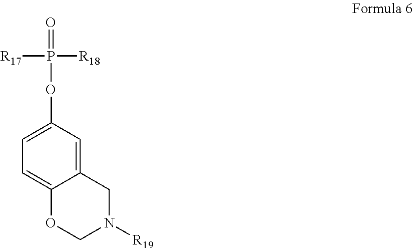
wherein, in Formula 6, R₁₇ and R₁₈ are each independently a C₁-C₂₀ alkyl group, a C₁-C₂₀ alkoxy group, a C₆-C₂₀ aryl group, a C₆-C₂₀ aryloxy group, or a group represented by Formula 6A: 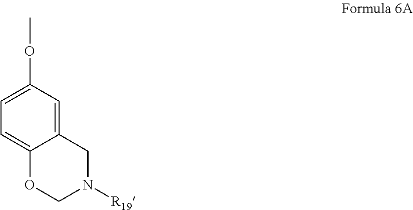
wherein, in Formulae 6 and 6A, R₁₉ and R₁₉′ are each independently a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ cycloalkyl group, a halogenated C₄-C₂₀ cycloalkyl group, a C₁-C₂₀ heterocyclic group, or a halogenated C₁-C₂₀ heterocyclic group, 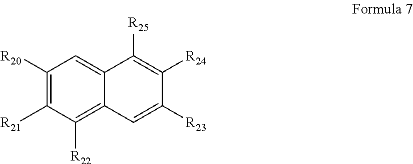
wherein, in Formula 7, two adjacent groups selected from R₂₀, R₂₁, and R₂₂ are linked to form a group represented by Formula 7A;
the unselected rest of R₂₀, R₂₁ and R₂₂ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbocyclic group, a halogenated C₄-C₂₀ carbocyclic group, a C₁-C₂₀ heterocyclic group, or a halogenated C₁-C₂₀ heterocyclic group;
two adjacent groups selected from R₂₃, R₂₄, and R₂₅ are linked to form a group represented by Formula 7A; and
the unselected rest of R₂₃, R₂₄ and R₂₅ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbocyclic group, a halogenated C₄-C₂₀ carbocyclic group, a C₁-C₂₀ heterocyclic group, or a halogenated C₁-C₂₀ heterocyclic group, 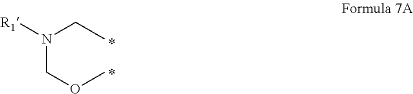
wherein, in Formula 7A, R₁′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and
* denotes the sites at which the two adjacent groups selected from R₂₀, R₂₁ and R₂₂ of Formula 7 are linked, and the two adjacent groups selected from R₂₃, R₂₄ and R₂₅ of Formula 7 are linked.

2. The composition of claim 1, further comprising a phosphoric acid-based material.

3. The composition of claim 2, wherein an amount of the phosphoric acid-based material is from about 270 parts to about 500 parts by weight based on 100 parts by weight of the compound of Formula 1.

4. The composition of claim 1, wherein, in Formula 1, a is a number from 0.01 to 0.7.

5. The composition of claim 1, wherein, in Formula 1, x is 2, and y is 7.

6. The composition of claim 1, wherein the compound of Formula 1 is selected from the group comprising Sn_{0.9}In_{0.1}P₂O₇, Sn_{0.95}Al_{0.05}P₂O₇, Ti_{0.9}In_{0.1}P₂O₇, Ti_{0.95}Al_{0.05}P₂O₇, Zr_{0.9}In_{0.1}P₂O₇, Zr_{0.95}Al_{0.05}P₂O₇, W_{0.9}In_{0.1}P₂O₇, W_{0.95}Al_{0.05}P₂O₇, Sn_{0.7}Li_{0.3}P₂O₇, Sn_{0.95}Li_{0.05}P₂O₇, Sn_{0.9}Li_{0.1}P₂O₇, Sn_{0.8}Li_{0.2}P₂O₇, Sn_{0.6}Li_{0.4}P₂O₇, Sn_{0.5}Li_{0.5}P₂O₇, Sn_{0.7}Na_{0.3}P₂O₇, Sn_{0.7}K_{0.3}P₂O₇, Sn_{0.7}Cs_{0.3}P₂O₇, Zr_{0.9}Li_{0.1}P₂O₇, Ti_{0.9}Li_{0.1}P₂O₇, Si_{0.9}Li_{0.1}P₂O₇, Mo_{0.9}Li_{0.1}P₂O₇, W_{0.9}Li_{0.1}P₂O₇, Sn_{0.7}Mg_{0.3}P₂O₇, Sn_{0.95}Mg_{0.05}P₂O₇, Sn_{0.9}Mg_{0.1}P₂O₇, Sn_{0.8}Mg_{0.2}P₂O₇, Sn_{0.6}Mg_{0.4}P₂O₇, Sn_{0.5}Mg_{0.5}P₂O₇, Sn_{0.7}Ca_{0.3}P₂O₇, Sn_{0.7}Sr_{0.3}P₂O₇, Sn_{0.7}Ba_{0.3}P₂O₇, Zr_{0.9}Mg_{0.1}P₂O₇, Ti_{0.9}Mg_{0.1}P₂O₇, Si_{0.9}Mg_{0.1}P₂O₇, Mo_{0.9}Mg_{0.1}P₂O₇, W_{0.9}Mg_{0.1}P₂O₇, Zr_{0.7}Mg_{0.3}P₂O₇, Ti_{0.7}Mg_{0.3}P₂O₇, Si_{0.7}Mg_{0.3}P₂O₇, Mo_{0.7}Mg_{0.3}P₂O₇, and W_{0.7}Mg_{0.3}P₂O₇.

7. The composition of claim 1, wherein an amount of the compound represented by Formula 1 is from about 1 part to about 150 parts by weight based on 100 parts by weight of the azole-based polymer and the at least one of compounds represented by Formulae 2-7.

8. The composition of claim 1, wherein an amount of the at least one of compounds represented by Formulae 2-7 is from about 10 parts to about 70 parts by weight based on 100 parts by weight of the azole-based polymer and the at least one of compounds represented by Formulae 2-7.

9. The composition of claim 1, wherein the azole-based polymer is 2,5-polybenzimidazole, poly(2,2′-(m-phenylene)-5,5′-bibenzimidazole), or poly(2,2′-(p-phenylene)-5,5′-bibenzimidazole).

10. A composite that is a polymerization product of the composition of claim 1.

11. A composite membrane for a fuel cell comprising the composite of claim 10.

12. The composite membrane of claim 11, wherein a doping level of the phosphoric acid-based material in the electrolyte membrane is from about 200% to about 350%.

13. An electrode for a fuel cell, the electrode comprising the composition of claim 1 or a composite that is a polymerization product of the composition.

14. A fuel cell comprising:
a cathode;
an anode; and
an electrolyte membrane disposed between the cathode and the anode, wherein the electrolyte membrane comprises the composite of claim 10.

15. A fuel cell comprising:
a cathode;
an anode; and
an electrolyte membrane disposed between the cathode and the anode,
wherein at least one of the cathode and the anode comprises the composition of claim 1, or a composite that is a polymerization product of the composition.

16. A method of preparing an electrolyte membrane for a fuel cell, the method comprising:
contacting a compound represented by Formula 1, an azole-based polymer, and at least one of compounds represented by Formulae 2-7 to obtain a composition;
coating the composition to obtain a coated composition; and
thermally treating the coated composition to obtain the electrolyte membrane comprising a composite that is a polymerization product of the compound represented by Formula 1, the azole-based polymer, and the at least one of compounds of Formulae 2-7:
M¹₁₋ₐM²ₐPₓO_{y} Formula 1
wherein, in Formula 1 above, M¹ is a tetravalent element;
M² is at least one selected from the group comprising a monovalent element, a divalent element, and a trivalent element;
0≦a<1;
x is a number from 1.5 to 3.5; and
y is a number from 5 to 13, 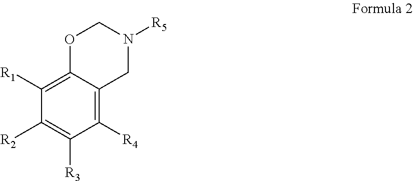
wherein, in Formula 2, R₁, R₂, R₃, and R₄ are each independently a hydrogen atom, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₂-C₂₀ heteroaryl group, a substituted or unsubstituted C₂-C₂₀ heteroaryloxy group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, a halogen atom, a hydroxyl group, or a cyano group; and
R₅ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group, 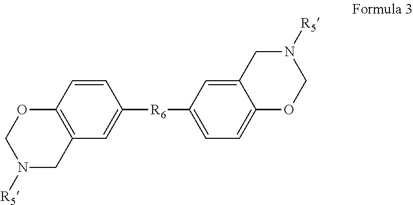
wherein, in Formula 3, R₅′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and
R₆ is a substituted or unsubstituted C₁-C₂₀ alkylene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₂-C₂₀ heteroarylene group, —C(═O)—, or —SO₂—, 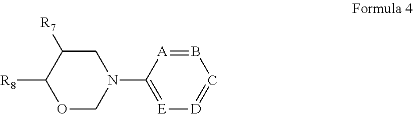
wherein, in Formula 4, wherein A, B, C, D and E are carbon, or one or two of A, B, C, D and E is nitrogen and the others are carbon; and R₇ and R₈ are linked to form a ring, wherein the ring is a C₆-C₁₀ cycloalkyl group, a C₃-C₁₀ heteroaryl group, a fused C₃-C₁₀ heteroaryl group, a C₃-C₁₀ heterocyclic group or a fused C₃-C₁₀ heterocyclic group, 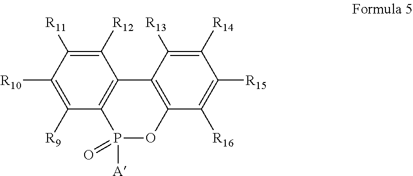
wherein, in Formula 5, A′ is a substituted or unsubstituted C₁-C₂₀ heterocyclic group, a substituted or unsubstituted C₄-C₂₀ cycloalkyl group, or a substituted or unsubstituted C₁-C₂₀ alkyl group; and
R₉ to R₁₆ are each independently a hydrogen atom, a C₁-C₂₀ alkyl group, a C₁-C₂₀ alkoxy group, a C₆-C₂₀ aryl group, a C₆-C₂₀ aryloxy group, a C₁-C₂₀ heteroaryl group, a C₁-C₂₀ heteroaryloxy group, a C₄-C₂₀ cycloalkyl group, a C₁-C₂₀ heterocyclic group, a halogen atom, a cyano group, or a hydroxy group, 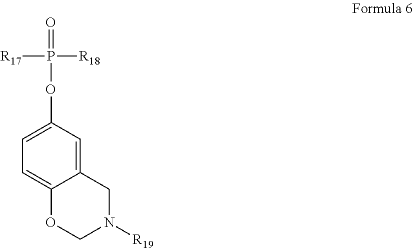
wherein, in Formula 6, R₁₇ and R₁₈ are each independently a C₁-C₂₀ alkyl group, a C₁-C₂₀ alkoxy group, a C₆-C₂₀ aryl group, a C₆-C₂₀ aryloxy group or a group represented by Formula 6A: 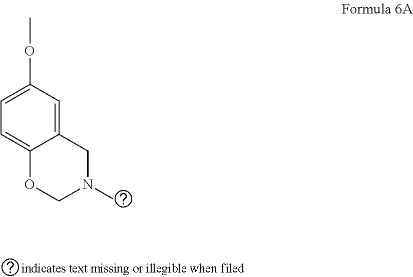
wherein, in Formulae 6 and 6A, R₁₉ and R₁₉′ are each independently a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ cycloalkyl group, a halogenated C₄-C₂₀ cycloalkyl group, a C₁-C₂₀ heterocyclic group, or a halogenated C₁-C₂₀ heterocyclic group, 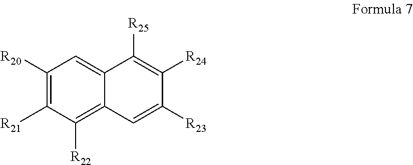
wherein, in Formula 7, two adjacent groups selected from R₂₀, R₂₁, and R₂₂ are linked to form a group represented by Formula 7A;
the unselected rest of R₂₀, R₂₁ and R₂₂ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbocyclic group, a halogenated C₄-C₂₀ carbocyclic group, a C₁-C₂₀ heterocyclic group or a halogenated C₁-C₂₀ heterocyclic group;
two adjacent groups selected from R₂₃, R₂₄, and R₂₅ are linked to form a group represented by Formula 7A; and
the unselected rest of R₂₃, R₂₄ and R₂₅ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbocyclic group, a halogenated C₄-C₂₀ carbocyclic group, a C₁-C₂₀ heterocyclic group, or a halogenated C₁-C₂₀ heterocyclic group, 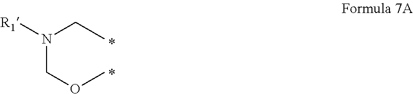
wherein, in Formula 7A, R₁′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and
* denotes the sites at which the two adjacent groups selected from R₂₀, R₂₁ and R₂₂ of Formula 7 are linked, and the two adjacent groups selected from among R₂₃, R₂₄ and R₂₅ of Formula 7 are linked.

17. The method of claim 16, wherein the electrolyte membrane further comprises a phosphoric acid-based material.

18. The method of claim 16, wherein an amount of the compound represented by Formula 1 is from about 1 part to about 150 parts by weight based on 100 parts by weight of the azole-based polymer and the at least one of compounds represented by Formulae 2-7.

19. The method of claim 16, wherein an amount of the at least one of compounds represented by Formulae 2-7 is from about 30 parts to about 70 parts by weight based on 100 parts by weight of the azole-based polymer and the at least one of compounds represented by Formulae 2-7.

20. The method of claim 16, wherein the azole-based polymer is 2,5-polybenzimidazole, poly(2,2′-(m-phenylene)-5,5′-bibenzimidazole), or poly(2,2′-(p-phenylene)-5,5′-bibenzimidazole).
